(19) United States
(12) Patent Application Publication
(10) Pub. No.: US 2018/0375842 A1
(43) Pub. Date: Dec. 27, 2018

(54) METHODS AND SECURITY CONTROL APPARATUSES FOR TRANSMITTING AND RECEIVING CRYPTOGRAPHICALLY PROTECTED NETWORK PACKETS

(71) Applicant: SIEMENS AKTIENGESELLSCHAFT, MÜNCHEN (DE)

(72) Inventors: HANS ASCHAUER, MÜNCHEN (DE); RAINER FALK, POING (DE); KAI FISCHER, BALDHAM (DE); STEFFEN FRIES, BALDHAM (DE); MARKUS HEINTEL, MÜNCHEN (DE); WOLFGANG KLASEN, OTTOBRUNN (DE); AXEL PFAU, MÜNCHEN (DE)

(21) Appl. No.: 16/017,419

(22) Filed: Jun. 25, 2018

(30) Foreign Application Priority Data
Jun. 26, 2017 (EP) 17177901.0

(51) Int. Cl. H04L 29/06

(52) U.S. Cl. CPC H04L 63/0485; H04L 63/123; H04L 63/0227

(57) ABSTRACT

A modular security control apparatus for the protected transfer of network packets is provided. In particular, an exchange of network data (e.g. network packets) between a first internal source network and a second internal network (e.g. second destination network) via a non-trustworthy internal and/or external network (first destination network) is made possible.

### CROSS-REFERENCE TO RELATED APPLICATIONS

This application claims priority to European application No. EP17177901.0 having a filing date of Jun. 26, 2017 the entire contents of both of which are hereby incorporated by reference.

### FIELD OF TECHNOLOGY

There is a need to enable a secure exchange of network packets in order that industrial installations can be controlled via a data communication connection.

### SUMMARY

An aspect relates to methods and security control apparatuses which allow industrial installations to be controlled securely.

In accordance with a first aspect, embodiments of the invention relate to a first modular security control apparatus for transmitting cryptographically protected network packets, comprising:
a control basic device;
a classification unit, wherein
   the classification unit is configured by means of a packet filter for selecting network packets using predefined selection parameters;
a security module, wherein
   the security module is configured for a cryptographic processing of at least one network packet portion of the selected network packets,
   the security module is connected to the control basic device by means of a data connection via a data interface;
   the control basic device is configured in particular for interrogating an identity and/or authenticity of the security module;
a packet adapting unit, wherein
   the packet adapting unit is configured to adapt the cryptographically processed network packets to a first destination network,
the control basic device is configured for cooperating with the security module in order that the first modular security control apparatus transmits the cryptographically processed network packets as cryptographically protected network packets to the first destination network.

Unless indicated otherwise in the description below, the terms “carry out”, “calculate”, “computer-aided”, “compute”, “ascertain”, “generate”, “configure”, “reconstruct” and the like preferably relate to acts and/or processes and/or processing steps which alter and/or generate data and/or convert the data into other data, wherein the data can be represented or be present in particular as physical variables, for example as electrical pulses. In particular, the expression “computer” should be interpreted as broadly as possible in order to cover in particular all electronic devices having data processing properties. Computers can thus be for example personal computers, servers, programmable logic controllers (PLCs), handheld computer systems, pocket PC devices, mobile radio devices and other communication devices which can process data in a computer-aided manner, processors and other electronic devices for data processing.

In connection with embodiments of the invention “computer-aided” can be understood to mean for example an implementation of the method in which in particular a processor performs at least one method step of the method.

In connection with embodiments of the invention a processor can be understood to mean for example a machine or an electronic circuit. A processor can be in particular a central processing unit (CPU), a microprocessor or a microcontroller, for example an application-specific integrated circuit or a digital signal processor, possibly in combination with a memory component (e.g. a hard disk, a flash memory or a main memory) for storing program commands, etc. A processor can for example also be an IC (Integrated Circuit), in particular an FPGA (Field Programmable Gate Array) or an ASIC (Application-Specific Integrated Circuit), or a DSP (Digital Signal Processor) or a GPU (Graphic Processing Unit). A processor can also be understood to mean a virtualized processor, a virtual machine or a soft CPU. By way of example, it can also be a programmable processor which is equipped with configuration steps for performing the abovementioned method according to embodiments of the invention or is configured with configuration steps in such a way that the programmable processor realizes the features according to embodiments of the invention of the method, of the component, of the modules, or of other aspects and/or partial aspects of embodiments of the invention.

In connection with embodiments of the invention a “memory unit”, “memory module”, “memory component” and the like can be understood to mean for example a volatile memory in the form of main memory (Random-Access Memory, RAM) or a permanent memory such as a hard disk or a data carrier.

In connection with embodiments of the invention a “module”, “unit” and the like can be understood to mean for example a processor and/or a memory for storing program commands. By way of example, the processor is specifically configured to execute the program commands in such a way that the processor executes functions for realizing the method according to embodiments of the invention or one of its exemplary embodiments.

In connection with embodiments of the invention “cryptographic processing” and the like can be understood to mean for example encryption or protection by a digital signature. In particular the network packet portion of a selected network packet will thereby be protected. In this context, canceling a cryptographic protection can be understood to mean in particular decryption. In this context, evaluating the cryptographically protected network packets can be understood to mean for example checking the digital signature.

In connection with embodiments of the invention a “cryptographic functionality” and the like can be understood to mean in particular cryptographic processing, canceling a cryptographic protection or evaluating a cryptographic protection. By way of example, the cryptographic functionality is applied to the cryptographically protected network packets or to the network packets that are to be cryptographically processed.

In connection with embodiments of the invention “classification”, “classifying”, “selecting” and the like can be understood to mean in particular selecting network packets on the basis of predefined (selection) parameters.

In connection with embodiments of the invention “packet supplementary data” or “tag” can be understood to mean in particular information about a subnetwork mask, a destination address in the form of an IP address or a protocol type (e.g. IPv4 or IPv6). In connection with embodiments of the invention “packet supplementary data” or “tag” can for example also be understood to mean an Ethertype, structure information such as position/limits and length of the payload from higher network layers (e.g. start and end offset of the IP payload in an Ethernet frame).

In connection with embodiments of the invention a “secure interface” and the like can be understood to mean in particular an interface which can be used for example only if the identity and/or the authenticity of a user/invoking entity of the secure interface have/has been ascertained and/or accepted. This can be realized for example by means of digital signatures or certificates. By way of example, a respective list can be stored in the secure interfaces of the corresponding units or the units themselves, said list stipulating which identities or users are permitted to access the secure interface or it is possible to store in said list stipulations regarding which user can read and/or write and/or use in particular which functions/actions and/or data from the interface. If it is ascertained for example that the user is not authorized to use a secure interface, then e.g. a corresponding request for performing a function/action is suppressed by the secure interface. If the user is authorized, for example, then in particular the corresponding function/action can be performed. In this case, a user can be understood to mean in particular some other unit, the control basic device or else the security module. In connection with embodiments of the invention a “secure interface” and the like can in particular also be understood to mean an interface having for example specific physical properties (e.g. physically defined point-to-point communication if appropriate with tamper protection in order to identify an alteration). This can for example also be achieved by access to the interfaces being access-restricted.

The first modular security control apparatus is advantageous to the effect of enabling in particular an exchange of network data (e.g. network packets) between a first internal source network and a second internal network (e.g. second destination network) via a non-trustworthy internal and/or external network (first destination network).

To that end, in particular the network data are subjected to a cryptographic processing. The cryptographically processed network data are in particular packaged again as network packets (encapsulation) after the cryptographic processing. In addition, by way of example, an adaptation to the properties (protocol, network layer) of the external network is also necessary (e.g. Ethernet, TCP/IP, MPLS).

In a first embodiment of the first modular security control apparatus, the security module comprises the packet adapting unit and/or the classification unit.

The first modular security control apparatus is advantageous to the effect of separating in particular the work steps for cryptographic processing and the possibly required protocol adaptations from one another. By way of example, by means of a skillful choice of the interfaces and minimization of mutual dependencies, it is possible to achieve long-term security and/or crypto agility and/or freedom from feedback, which are important particularly in the industrial sphere. In this case, freedom from feedback can be understood to mean, for example, that there is in particular only one defined data path for transmitting data, and the data are necessarily cryptographically processed in particular on this path.

The following allows in particular the simple realization of a network component on a shared hardware platform which is suitable for protecting both L2 and L3 network traffic in particular also for protection at the transport level, application protocol level or of application data. Particularly the separation and linking of the units and/or of the control basic device and/or of the security module via an API/ABI (application binary interface, (ABI) application programming interface, (API)) interface that is narrow and nevertheless universally applicable with different cryptographic algorithms and encryption methods enables the simple integration of (customer-)specific adaptation of the cryptographic functionality. In this case, a narrow API/ABI interface or a secure interface can be understood to mean for example predefined data structures for data exchange, protected memory areas for data exchange, memory areas having defined read and write rights for the units and/or the security module and/or the control basic device. A narrow API/ABI interface is advantageous since, in particular, only a small attack area exists. Therefore, such a narrow interface can be realized efficiently with high quality. For this purpose, by way of example, properties for parameters of the interface are defined, such as key length, block length, etc.

In a further embodiment of the first modular security control apparatus, the control basic device comprises the packet adapting unit and/or the classification unit.

The first modular security control apparatus is advantageous to the effect of separating in particular the work steps for cryptographic processing and the possibly required protocol adaptations from one another. By way of example, by means of a skillful choice of the interfaces and minimization of mutual dependencies, it is possible to achieve long-term security and/or crypto agility and/or freedom from feedback, which are important particularly in the industrial sphere.

The following allows in particular the simple realization of a network component on a shared hardware platform which is suitable for protecting both L2 and L3 network traffic. Particularly the separation and linking of the units and/or of the control basic device and/or of the security module via a narrow API/ABI interface enables the simple integration of (customer-)specific adaptation of the cryptographic functionality. In this case, a narrow API/ABI interface or a secure interface can be understood to mean for example predefined data structures for data exchange, protected memory areas for data exchange, memory areas having defined read and write rights (e.g. for the units and/or the security module and/or the control basic device).

In a further embodiment of the first modular security control apparatus, the security module is releasably connected to the control basic device.

In a further embodiment of the first modular security control apparatus, the control basic device, with the security module having been released, is operable with a basic device functionality.

In a further embodiment of the first modular security control apparatus, the control basic device is furthermore configured for cooperating with a second security module—exchangeable for the security module—with a second cryptographic functionality for the cryptographic processing and/or a further security function of the security control apparatus.

In a further embodiment of the first modular security control apparatus, the control basic device comprises a housing, wherein
in the housing a recess is formed and configured for at least partly receiving the security module,
furthermore, an interface connection element for the data interface is provided in the control basic device in such a way that, with the security module having been received in the recess, a data exchange between control basic device and security module takes place.

In a further embodiment of the first modular security control apparatus, the classification unit is configured for storing packet supplementary data for a respective network packet and/or the packet adapting unit takes account of at least one portion of the packet supplementary data during adapting and/or the first security module takes account of at least one portion of the packet supplementary data during cryptographic processing.

In a further embodiment of the first modular security control apparatus, the units each have secure interfaces, wherein communication of data to the units or retrieval of data from the units is able to be carried out exclusively via the respective secure interface.

In accordance with a further aspect, embodiments of the invention relate to a second modular security control apparatus for receiving cryptographically protected network packets, comprising:
a control basic device;
a classification unit, wherein
the classification unit is configured by means of a packet filter for selecting network packets using predefined selection parameters,
at least one network packet portion of the selected network packets is cryptographically protected;
a security module, wherein
the security module is configured for canceling and/or evaluating a cryptographic protection of the protected network packet portion of the selected network packets,
the security module is connected to the control basic device by means of a data connection via a data interface,
the control basic device is configured in particular for interrogating an identity and/or authenticity of the security module;
a packet adapting unit, wherein
the packet adapting unit is configured to adapt the evaluated and/or the network packets without cryptographic protection to a second destination network,
the control basic device is configured for cooperating with the security module in order that the second modular security control apparatus transmits the evaluated and/or the network packets without cryptographic protection to the second network.

In a further embodiment of the second modular security control apparatus, an integrity and/or authenticity of the network packets is checked during evaluation, wherein in particular the transmission of the network packets into the second network is suppressed depending on a result of the evaluation (e.g. if a digital signature could not be successfully confirmed/verified).

In a further embodiment of the second modular security control apparatus, the classification unit is configured for storing packet supplementary data for a respective network packet, and/or the packet adapting unit takes account of at least one portion of the packet supplementary data during adapting, and/or the second security module takes account of at least one portion of the packet supplementary data during evaluation or cancellation of the cryptographic protection.

In accordance with a further aspect, embodiments of the invention relate to a method for transmitting cryptographically protected network packets comprising the following method steps:
selecting network packets by means of a packet filter using predefined selection parameters;
cryptographically processing at least one network packet portion of the respectively selected network packets;
adapting the cryptographically processed network packets to a first destination network;
transmitting the cryptographically processed network packets as cryptographically protected network packets to the first destination network.

In accordance with a further aspect, embodiments of the invention relate to a method for receiving cryptographically protected network packets comprising the following method steps:
receiving and selecting network packets by means of a packet filter using predefined selection parameters, wherein at least one portion of a respective network packet is cryptographically protected;
canceling and/or evaluating a cryptographic protection of the protected network packet portion of the respectively selected network packets;
adapting the evaluated network packets and/or the network packets without cryptographic protection to a second destination network;
transmitting the evaluated network packets and/or the network packets without cryptographic protection to the second destination network.

Furthermore, a computer program product (non-transitory computer readable storage medium having instructions, which when executed by a processor, perform actions) comprising program commands for carrying out the abovementioned methods according to embodiments of the invention is claimed, wherein in each case one of the methods according to embodiments of the invention, all of the methods according to embodiments of the invention or a combination of the methods according to embodiments of the invention can be carried out by means of the computer program product.

In addition, a variant of the computer program product comprising program commands for the configuration of a construction device, for example a 3D printer, a computer system or a production machine suitable for constructing processors and/or devices, is claimed, wherein the construction device is configured by the program commands in such a way that the abovementioned modular security control apparatuses according to embodiments of the invention are constructed.

Furthermore, a providing device for storing and/or providing the computer program product is claimed. The providing device is for example a data carrier that stores and/or provides the computer program product. Alternatively and/or additionally, the providing device is for example a network service, a computer system, a server system, in particular a distributed computer system, a cloud-based computer system and/or virtue computer system which stores and/or provides the computer program product preferably in the form of a data stream.

This providing is implemented for example as a download in the form of a program data block and/or command data block, preferably as a file, in particular as a download file, or as a data stream, in particular as a download data stream, of the complete computer program product. However, this providing can for example also be implemented as a partial download which consists of a plurality of parts and is downloaded or provided as a data stream in particular via a peer-to-peer network. Such a computer program product is read into a system for example using the providing device in the form of the data carrier and executes the program commands, such that the method according to embodiments of the invention is performed on a computer or configures the construction device in such a way that it constructs the modular security control apparatus(es) according to embodiments of the invention.

### BRIEF DESCRIPTION

Some of the embodiments will be described in detail, with references to the following Figures, wherein like designations denote like members, wherein:

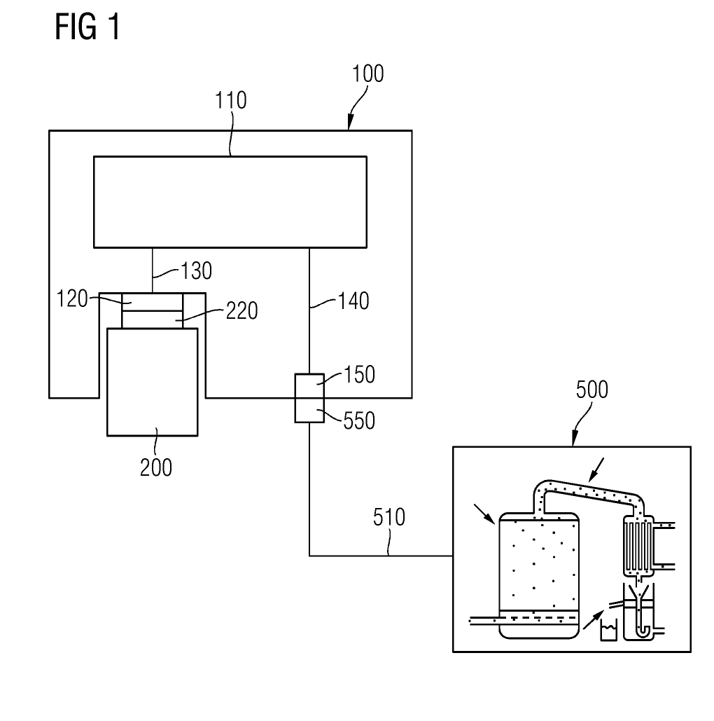

FIG. 1 shows an exemplary controller with security module for controlling an installation;

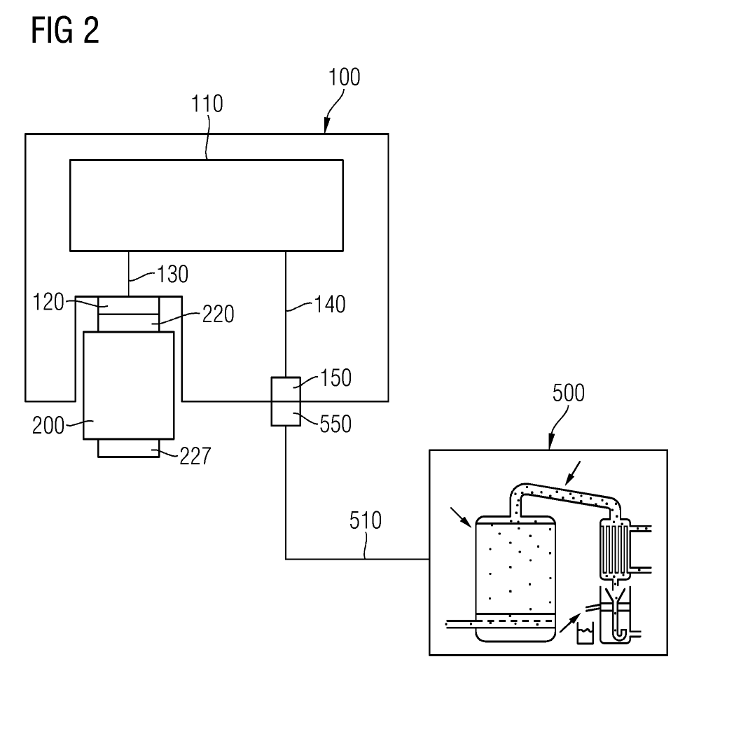

FIG. 2 shows a control apparatus in accordance with FIG. 1 with an external modular interface of the security module;

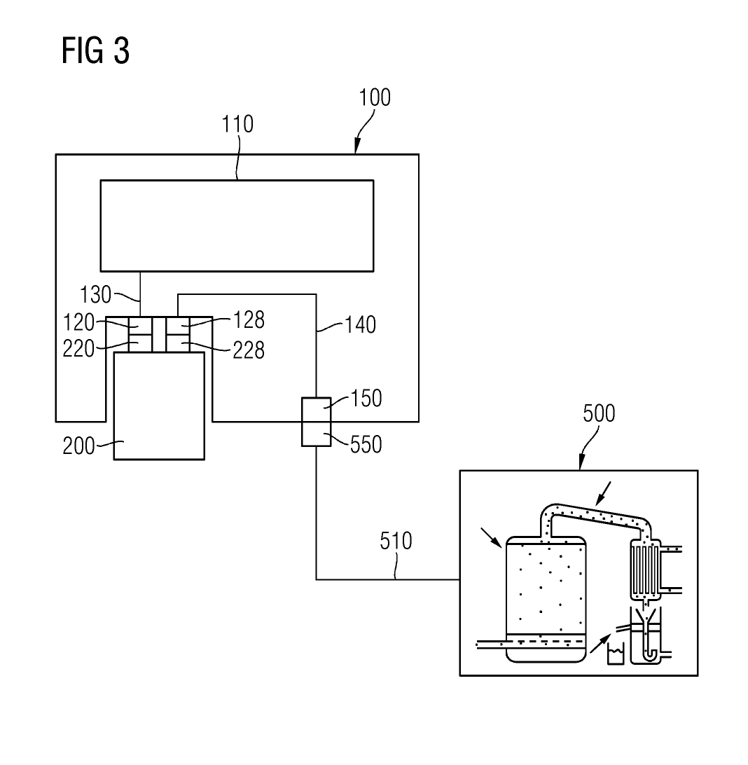

FIG. 3 shows a control apparatus in accordance with FIG. 1 with modified internal communication;

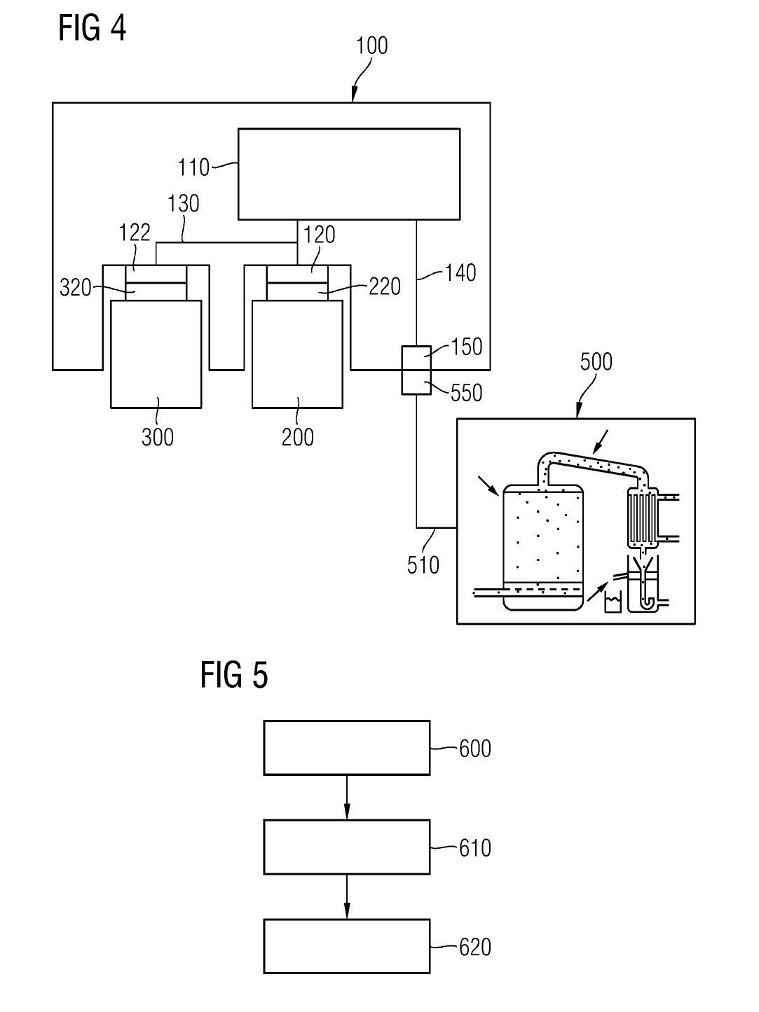

FIG. 4 shows a control apparatus in accordance with FIG. 1 with a second security module;

FIG. 5 shows an exemplary method sequence during the cryptographic processing of data;

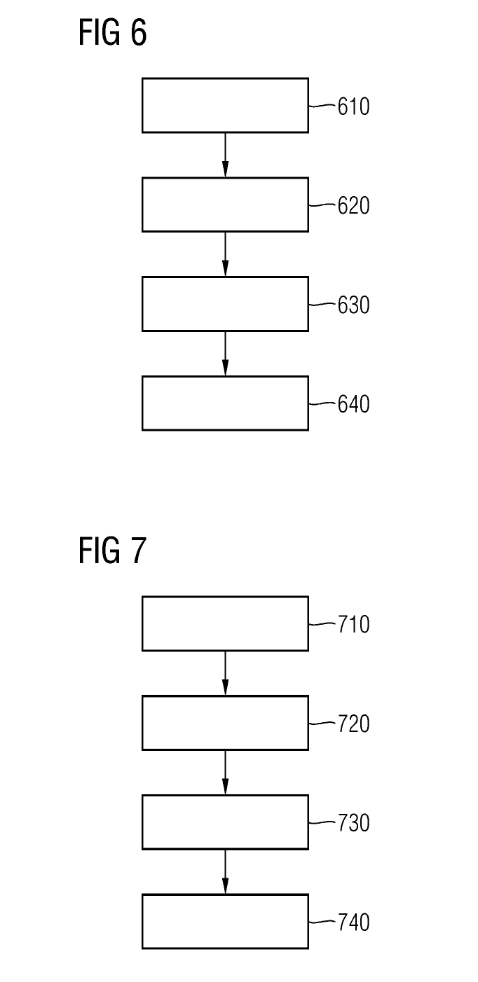

FIG. 6 shows a further exemplary embodiment of the invention as a flow diagram;

FIG. 7 shows a further exemplary embodiment of the invention as a flow diagram;

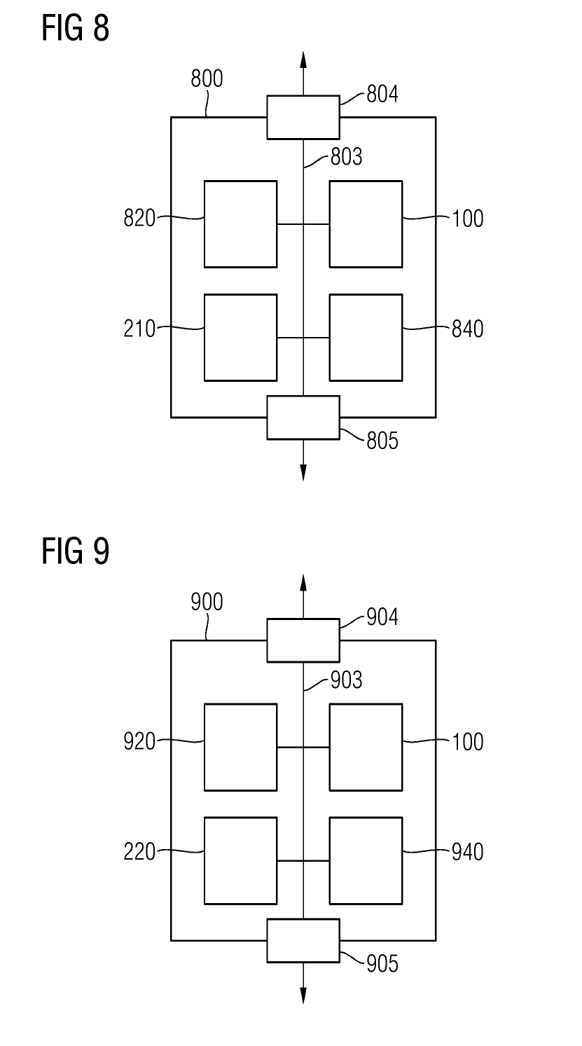

FIG. 8 shows a further exemplary embodiment of the invention as a device;

FIG. 9 shows a further exemplary embodiment of the invention as a device;

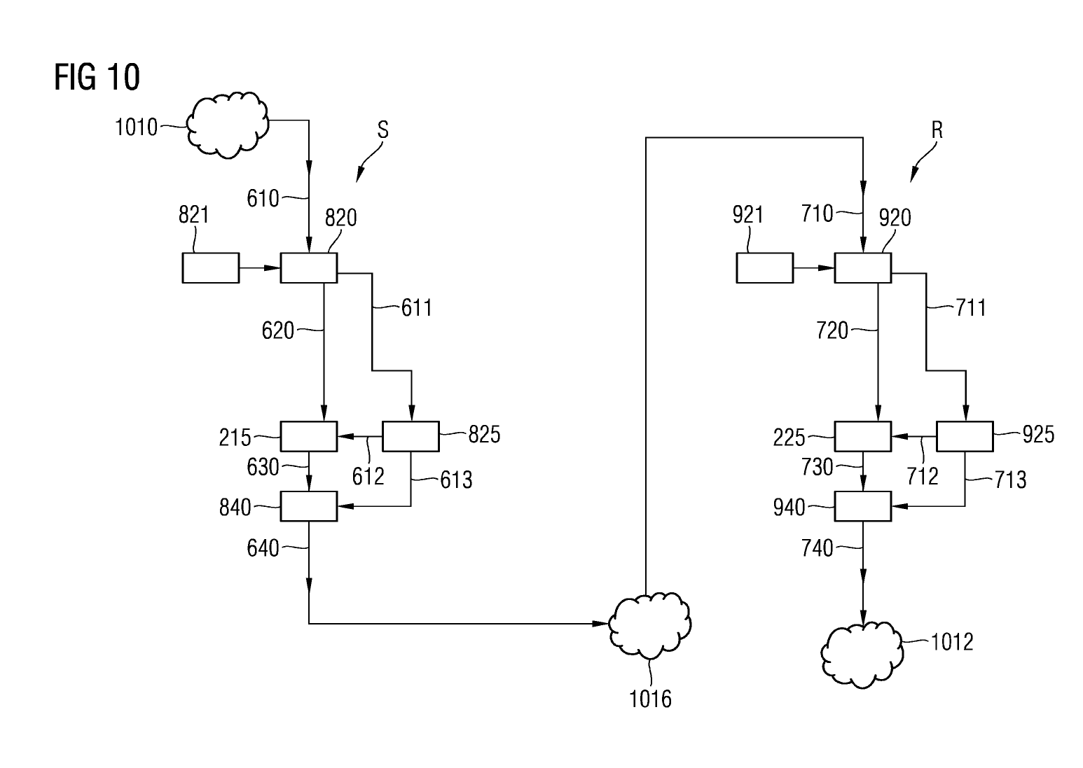

FIG. 10 shows a further exemplary embodiment of the invention as a device;

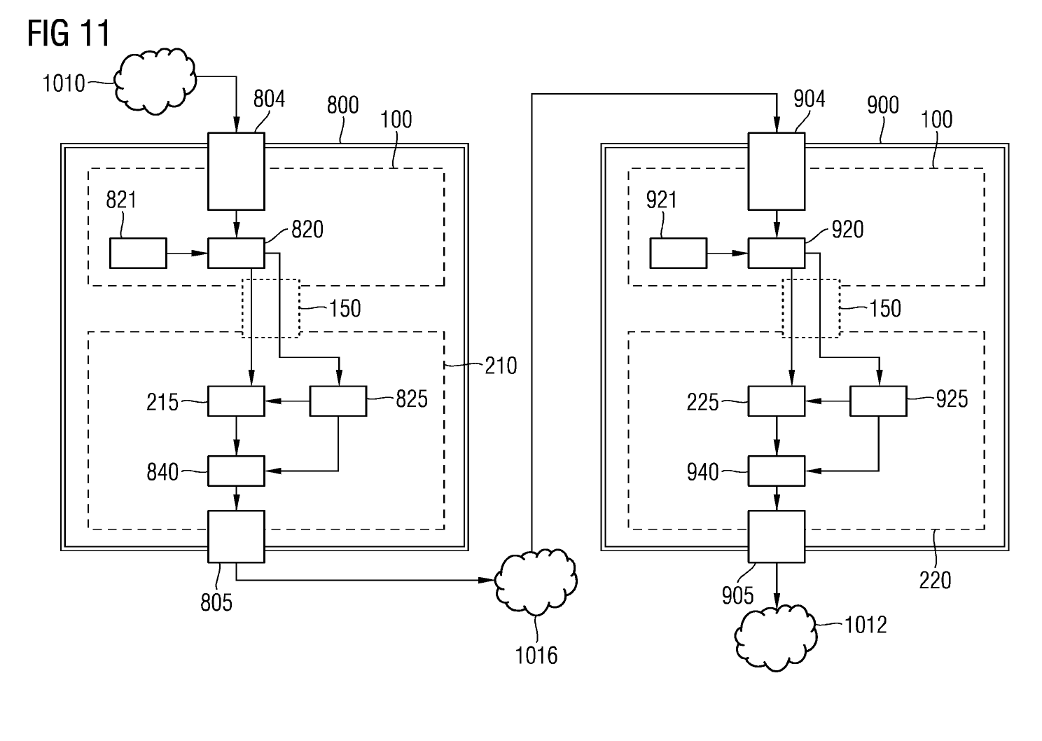

FIG. 11 shows a further exemplary embodiment of the invention as a device;

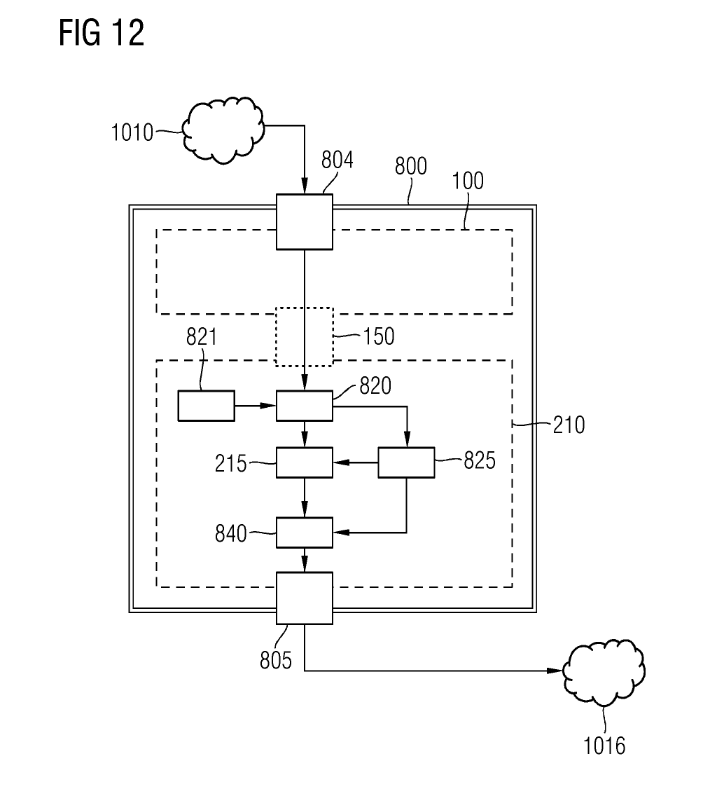

FIG. 12 shows a further exemplary embodiment of the invention as a device;

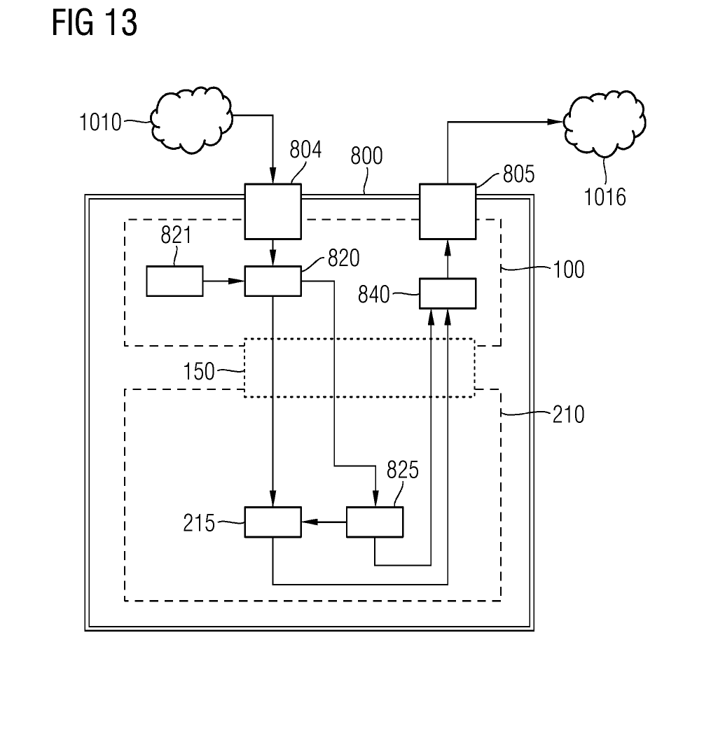

FIG. 13 shows a further exemplary embodiment of the invention as a device; and

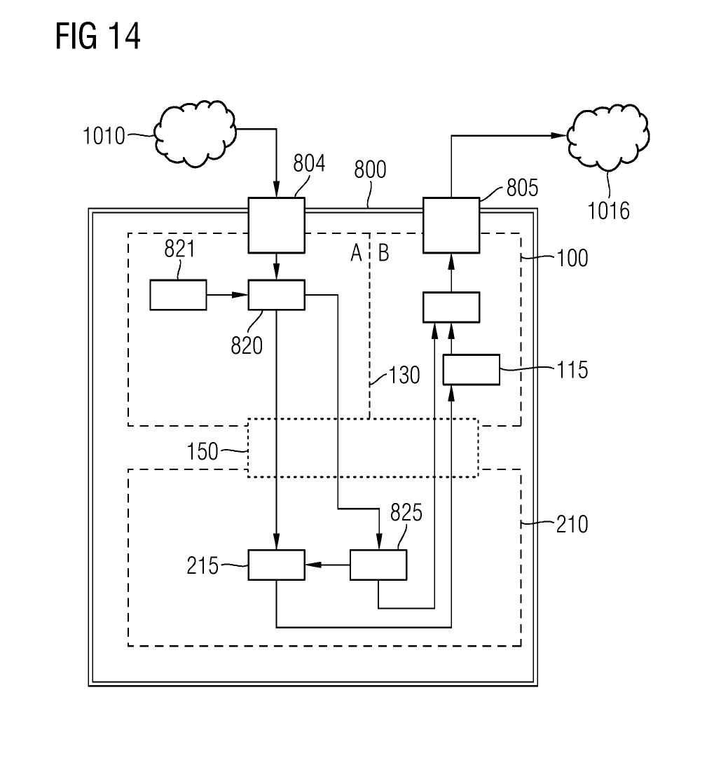

FIG. 14 shows a further exemplary embodiments of the invention as a device.

### DETAILED DESCRIPTION

In the figures, functionally identical elements are provided with the same reference signs, unless indicated otherwise.

The exemplary embodiments below comprise, unless indicated otherwise or already indicated, at least one processor and/or one memory component in order to implement or perform the method.

Moreover, in particular a (relevant) person skilled in the art, with knowledge of the method claim/method claims, is of course aware of all routine possibilities for realizing products or possibilities for implementation in the prior art, and so there is no need in particular for independent disclosure in the description. In particular, these customary realization variants known to the person skilled in the art can be realized exclusively by hardware (components) or exclusively by software (components). Alternatively and/or additionally, the person skilled in the art, within the scope of his/her expert ability, can choose to the greatest possible extent arbitrary combinations according to embodiments of the invention of hardware (components) and software (components) in order to implement realization variants according to embodiments of the invention.

A combination according to embodiments of the invention of hardware (components) and software (components) can occur in particular if one portion of the effects according to embodiments of the invention is brought about preferably exclusively by special hardware (e.g. a processor in the form of an ASIC or FPGA) and/or another portion by the (processor- and/or memory-aided) software.

In particular, in view of the high number of different realization possibilities, it is impossible and also not helpful or necessary for the understanding of embodiments of the invention to name all these realization possibilities. In this respect, in particular all the exemplary embodiments below are intended to demonstrate merely by way of example a few ways in which in particular such realizations of the teaching according to embodiments of the invention could be manifested.

Consequently, in particular the features of the individual exemplary embodiments are not restricted to the respective exemplary embodiment, but rather relate in particular to embodiments of the invention in general. Accordingly, features of one exemplary embodiment can preferably also serve as features for another exemplary embodiment, in particular without this having to be explicitly stated in the respective exemplary embodiment.

For embodiments of the invention, firstly an explanation is given of the design possibilities for the modular security control apparatuses and how the security module can be linked for example to the control basic device. These exemplary embodiments can be applied without problems in particular to the exemplary embodiments in FIGS. 6-13.

In the context of the present description the term “security” relates essentially to the security, confidentiality and/or integrity of data and the transfer thereof and also security, confidentiality and/or integrity during access to corresponding data. The authentication during data transfers and/or during data access is also encompassed by the term “security” as used in the context of the present description.

A modular security control apparatus of this type is formed and configured for controlling a device or an installation and comprises a control basic device, wherein the control basic device is formed and configured in such a way that a device that is connectable or connected to the control basic device, or an installation that is connectable or connected thereto, is controllable or is controlled by means of the sequence of a control program in the control basic device. Furthermore, the modular security control apparatus comprises a security module that is formed and configured for providing or implementing a cryptographic functionality (e.g. the cryptographic processing of the respective portion of the network packet in order to achieve a cryptographic protection of the network packet, the evaluation of the cryptographic protection and/or the cancellation of the cryptographic protection) for the control basic device. In this case, the security module is connected to the control basic device by means of a data connection via a data interface. The control basic device is formed and configured for cooperating with the security module for achieving a security function of the security control apparatus and for interrogating an identity and/or authenticity of the security module.

A modular security control apparatus of this type affords an improved possibility for example for data or communication security of a control apparatus of this type, since via the additional security module there is for example the possibility of adding own or externally developed security crypto-modules or similar modules for improving the security properties of the control apparatus. As a result of the cooperation of the functionality of the security module with the functionality already implemented in the basic device, it is thus possible, flexibly and if appropriate in a user-specific manner, for the security of a control apparatus to be improved and specifically and flexibly adapted.

Furthermore, in this way e.g. also by means of an independent implementation and/or own introduction of the security functionality in the context of the modular component a user can increase the trustworthiness of the security functionality since said user can thus utilize the high trustworthiness of the own controllable environment and is less or not dependent on the trustworthiness of third parties.

The abovementioned interrogation of identity and/or authenticity information makes it possible e.g. to check whether components provided only for the corresponding use are or can be used, which improves the security properties of the control apparatus even further.

The security control apparatus can be formed and configured for example as an automation system, a “controller”, a programmable logic controller (a so-called “PLC”), an industrial PC (a so-called “IPC”), a computer, if appropriate including a real-time system, a modular programmable logic controller or a similar control apparatus.

The installation controllable by means of the security control apparatus, or the controllable device, can be formed and configured for example as a production installation, a machine tool, a robot, an autonomous transport system and/or a similar apparatus, device or installation. By way of example, the device or the installation can be formed or provided for the manufacturing industry, the process industry, building automation and/or else power generation and distribution, for a traffic safety system and/or a traffic controller.

The control basic device can correspond for example to a control device or a controller without or with partial security functionality or else complete security function. Such a control device can be formed and configured for example as a central processing unit of a programmable logic controller, as a programmable logic controller, as an industrial PC, as a PC or similar apparatus.

In this case, the control basic device can comprise a real-time operating system, for example, which enables a real-time control of a device that is connected or connectable to the basic device or of an installation that is connected or connectable thereto.

The control basic device and/or the security module can comprise a housing, for example. The housing can be formed in such a way that the control basic device and/or the security module are/is protected against environmental influences. By way of example, housings of this type can be formed and configured in accordance with the “International Protection Classification” in accordance with DIN 60529, DIN 40050-9 and/or ISO 20653, e.g. in accordance with the classes IP65 or IP67.

A cryptographic functionality is generally understood to mean for example a function for encryption, for protection of confidentiality, for protection of integrity and/or for authentication of data (e.g. user data, control data, configuration data or administrative data).

In this case, the cryptographic functionality of the security module can comprise for example one or more of the functionalities listed below:
key storage
system and/or user authentication
certifying
encryption
decryption
calculating a cryptographic checksum (e.g. signature)
checking a cryptographic checksum (e.g. signature)
key agreement
key generation
generating random numbers (e.g. seed generation)
licensing
support of systematic monitoring functions (e.g. tamper protection, system integrity, SIEM)
monitoring data
validating data
filtering data

The cryptographic functionalities enumerated can each be implemented here once again by various methods or combinations of methods.

The data interface between the security module and the control basic device can be for example a wired or wireless interface. In this case, the data connection via a wired interface can be implemented for example via a combination of correspondingly complementary connector components or else via corresponding contact pads or contact pins. In this case, the data interface can be formed and configured as a serial or parallel data interface. Furthermore, the data interface between security module and control basic device can also be formed and configured as a wireless interface, e.g. a WLAN, Bluetooth or NFC interface (NFC: Near Field Communication).

Interrogating an identity and/or authenticity of the security module can comprise for example interrogating information regarding a model, a manufacturer, an author, one or more implemented or implementable crypto methods and/or crypto functionalities, version information, a firmware version or similar information, and/or interrogating the authenticity thereof. Furthermore, interrogating an identity and/or authenticity of the security module can comprise for example interrogating identity information such as, for example, type information, a model identification, an identification number or identifier or the like, and/or the authenticity of such information.

Furthermore, the security module can moreover also be mechanically connected to the control basic device, in particular releasably connected to the control basic device. Connections of this type can be effected for example via corresponding latching arrangements, clamping arrangements, screw joints or arbitrary combinations thereof.

Moreover, the energy supply of the security module is effected via the control basic device, for example via the data interface or else via a separate interface for energy supply. The energy supply of the security module can also be effected via a separate feed. The security module can also comprise a dedicated energy source such as, for example, a battery, a rechargeable battery, a capacitor and/or a comparable energy source.

The security function of the security control apparatus can be for example any function for encryption, for protection of confidentiality, for integrity protection, for authentication of data and/or the like. Data can be in this case e.g. user data, control data, configuration data and/or administrative data.

In this case, the respective security function of the security control apparatus is achieved by cooperation of control basic device and security module. Such cooperation can be for example the interrogation of security functionalities by the control basic device, e.g. the read-out of a key or interrogation of a corresponding checking result. Furthermore, the cooperation can also consist of a combination of a security or cryptographic method already provided in the control basic device with the cryptographic functionality of the security module.

Very generally, the cooperation of security module and control basic device in order to achieve the security function is understood to mean a procedure in which both of the components mentioned collaborate. In this case, a collaboration in the context of said cooperation can also already consist of interrogation or transfer of information. Alternatively, a collaboration in the context of said cooperation can also be designed in such a way that both the control basic device and the security module make a functional contribution regarding the security aspect in order to achieve the security function of the security control apparatus.

Furthermore, in order to achieve the security function, provision can be made for further components to cooperate with the control basic device and/or the security module. Components of this type can be for example one or more further security modules or else one or more further applications in the control basic device or an external device for achieving the security function.

In one advantageous design, the security module is releasably connected to the control basic device. In this way, the security properties of the security control apparatus are improved further since a security module releasably connected to the control basic device enables such a security module to be exchanged for a further security module. In this regard, e.g. security properties of the security control apparatus can be flexibly changed and/or adapted in order to adapt the device for example to altered boundary conditions or else to implement new, under certain circumstances improve, security methods.

In this context, a releasable connection is understood to mean one which remains fixed during a normal, technically routine use of the security control apparatus, and is released only upon specific measures being taken to release the connection or in the event of unusual force. Such a releasable connection can be for example, inter alia, a releasable mechanical connection of the security module to the control basic device, which connection can be formed e.g. as latching arrangement, screw joint or the like. Furthermore, in the case of a wired data interface between security module and control basic device, a releasable connection between these components can comprise a connection by means of corresponding plug elements and/or contact elements for establishing and releasing a corresponding data connection. A wired data connection of this type can also be additionally secured for example by means of specific security measures such as, for example, an additional latching arrangement or screw joint.

The control basic device can be formed and configured in such a way that, with a security module having been released, the control basic device is operable or is operated with a basic device functionality. In this case, a released security module is understood to be one which at least no longer has a communication connection to the control basic device.

In this way, the security functionality of the security control apparatus is flexibilized further by virtue of the fact that, for example in a trustworthy environment, a basic device functionality is available even without an additional security module.

In this case, a basic device functionality can comprise for example the complete functionality of a controller or of a programmable logic controller, for example also of a central processing unit of a programmable logic controller. Furthermore, the basic device functionality can also comprise already restricted security functions or else complete security functions. The basic device functionality can be provided for example in such a way as thereby to ensure at least a control of the installation to be controlled or of the device to be controlled to a conventional extent.

Furthermore, the control basic device can be formed and configured for cooperating with a second security module—exchangeable for the security module—with a second cryptographic functionality for achieving the security function and/or a further security function of the security control apparatus. In this way, the security properties of the security control apparatuses are improved further by virtue of the fact that e.g. the use of different security technologies is made possible in a flexible manner or else a security module can easily be exchanged or else replaced by an improved security module.

In this case, the second security module can be formed and configured in a manner corresponding to a security module in accordance with the present description. In particular, it can be formed in terms of shape and interface geometry in such a way that it can be connected to the control basic device and/or be fitted or introduced on or in the latter instead of the security module.

The connection of the second security module to the control basic device can in turn be effected via the data interface or else a further data interface. In this case, the cryptographic functionality of the second security module can be formed in a manner comparable to that of the security module and lead for example in turn to the security function of the security control apparatus being achieved. Furthermore, the second cryptographic functionality can also be different than the cryptographic functionality of the security module in such a way that a further security function—different than the security function—of the security control apparatus results or such a further security function becomes possible.

The control basic device can comprise a housing, for example, wherein a recess for at least partly receiving the security module is formed and configured in the housing. Furthermore, an interface connection element for the data interface is provided in the control basic device in such a way that, with the security module having been received in the recess, a data exchange between control basic device and security module takes place or can take place. In this way, the handling, and in particular secure handling, of the security control apparatus is facilitated since an inadvertent erroneous operation of the security module or of the entire control apparatus is thus made more difficult. In this case, the housing can be formed and configured already as described above, for example in accordance with an “International Protection” classification.

The recess can be formed and configured for example as an opening in the housing or a corresponding shaft for partly receiving or else wholly receiving the security module. In particular, a cover can furthermore be provided, in particular, which protects the security module or/and the corresponding interface elements against ambient influences and/or else erroneous operation and inadvertent withdrawal or damage. Furthermore, the recess can also be formed and configured for receiving a plurality of corresponding security modules. Interface connection elements can be formed for example as corresponding connector elements, contact elements or else antennas for a wireless interface.

In the case of the security control apparatus, a safeguard can be provided and configured in such a way that in a secured state of the security control apparatus an interruption and/or interception of the data connection between control basic device and security module is prevented or made more difficult, in particular that in the secured state the security module is still fixed relative to the control basic device.

Such a safeguard further improves the security properties of the security control apparatus since a disruption of the security functionality, for example by disconnecting the data connection between control basic device and security module, is prevented or made more difficult in this way. Such a safeguard can comprise for example a mechanical safeguard, e.g. a locking arrangement, a latching arrangement, a screw joint, a screw safeguard, a mechanical lock, a sealing arrangement, a seal or the like. In this case, by way of example, the entire security module can be correspondingly secured with the control basic device. Furthermore, an interruption of the data connection between security module and control basic device can also be correspondingly secured.

A safeguard can furthermore also be formed and configured in such a way that interception or tapping of information from the security module, from the control basic device or from the region of the data connection between security module and control basic device is prevented or made more difficult, e.g. by corresponding, for example mechanical, electrical and/or data-technological measures. Mechanical safeguards of this type can be for example corresponding shields, enclosures or other mechanical protection measures. Corresponding electrical safeguards can comprise for example sensors or corresponding safeguard switches which can detect and/or report an electrical contacting of the abovementioned elements or connections.

This also increases the security properties of the security control apparatus since in particular an illegal and/or unauthorized access to the security control apparatus and in particular also the security measures provided there can be prevented or at least made more difficult in this way.

Furthermore, provision can be made for identification information of the security module to be transferred to the control basic device via the data interface and to be stored in the control basic device. Provision can also be made for identification information of the control basic device to be transferred to the security module via the data interface and to be stored in the security module.

Transferring corresponding identification information makes it possible for example to identify the respective other partner, and thus for example to check an identity and/or authenticity of a respectively connected partner. This makes it possible to ensure, for example, that only permitted, allowed, suitable or correspondingly authorized security modules and/or control basic devices are combined or are combinable with the respective other component. The security properties of a corresponding apparatus can be further improved in this way, too.

In this case, identification information can comprise information regarding a model, a manufacturer, one or more implemented or implementable crypto methods and/or crypto functionalities, version information, a firmware version or similar information. The transfer of corresponding identification information from the security module to the control basic device can be effected for example at the request of the basic device. Correspondingly, the transfer of corresponding identification information from the control basic device to the security module can be effected for example at the request of the security module. This can take place for example in the context of an authentication process in the case of a newly connected security module or else as a regular status checking authentication process.

The corresponding identification information can be stored for example temporarily or else permanently. By way of example, the storage can also be effected permanently in the context of a corresponding list or database or a corresponding audit trail. This makes it possible for example to track when e.g. which security modules were connected to a corresponding control basic device. The security properties of a corresponding control apparatus can be further improved in this way, too.

The control basic device and/or security module can furthermore be formed and configured in such a way that an interruption and/or interception of the data connection between control basic device and security module are/is or can be identified, detected and/or logged.

By way of example, corresponding sensors or checking apparatuses can be provided for this purpose. If such a checking apparatus identifies for example that a communication connection between control basic device and security module is interrupted or disconnected, then this can be detected and logged for example in a corresponding database, e.g. including a point in time of the detection and further information. Such further information can be for example information regarding the control of the connected installation or of the connected device and a corresponding device and machine state. If a corresponding interception safeguard device identifies the interception of a data connection within the security module, the control basic device or between these two, then this can likewise be correspondingly detected and e.g. logged together with a point in time of detection and further information in a corresponding list or database.

Furthermore, provision can be made for a security-relevant action to be initiated after such identification, detection and/or logging of an interruption and/or interception of the data connection between control basic device and security module.

In this case, a security-relevant action of this type can be for example any action that concerns a security function of the modular security control apparatus, for example a corresponding alarm signal, a corresponding alarm message, erasure of keys, blocking of functionalities or further comparable and/or supplementary actions.

The control basic device can also be formed and configured for checking an identity and/or an authenticity of a security module connected via the data interface, wherein security basic device, security module and data interface can be formed and configured in accordance with the present description.

In this case, by way of example, it is possible to check identity information such as, for example, type information, a model identification, an identification number or identifier or the like, and/or the authenticity of such information. Furthermore, after an unsuccessful check of an identity or authenticity, for example, it is possible to initiate a security-relevant action in accordance with the present description.

The security module can also be formed and configured for checking an identity and/or authenticity of a control basic device connected via the data interface in accordance with the present description. Here, too, given unsuccessful checking of the identity and/or authenticity, it is possible to instigate or initiate a corresponding security-relevant action in accordance with the present description.

In this way, an improved security of the system is achieved by virtue of the fact that as a result of the abovementioned checking of identity and/or authenticity information with increased security only components provided for corresponding use are or can be used and correspondingly provided security standards can thus be complied with, for example.

The control basic device can furthermore comprise for example a data bus for data exchange with an external apparatus, wherein the data interface to the security module is formed and arranged within the control basic device in such a way that data exchanged between the control basic device and the external apparatus via the data bus are passed or can be passed through the security module.

In this way, by way of example, security modules can advantageously be used which are configured e.g. for a user-specific or exchangeable data identification or modification, for example an encryption or other cryptographic actions, wherein these are directly applicable to data transferred to the external apparatus or coming from the latter. In this way, corresponding encryption modules can be implemented in a corresponding security control apparatus in a flexible manner, for example.

External apparatuses can be for example input and/or output modules of a programmable logic controller, a controlled device or a controlled installation, a further controller, an operating apparatus (e.g. a so-called HMI: “Human Machine Interface”), an operating and observation system (e.g. a so-called “SCADA” system), a programming device, an engineering system or similar systems. In this way, by way of example, communication with systems of this type can be made more secure and furthermore the degree and the method of the applied security methods can also be flexibly adapted to the systems and specific environment or ambient conditions.

In this case, the control basic device can comprise one data bus or else a plurality of data buses. Furthermore, provision can be made for the communication of only one data bus, of a plurality of the data buses or else of all the data buses of a corresponding control basic device to be conducted via the corresponding security module.

Provision can also be made for the control basic device to comprise a data bus for data exchange with an external apparatus, and for the data interface to the security module to be formed and arranged within the control basic device in such a way that data exchanged between the control basic device and the external apparatus via the data bus are not passed through the security module.

A design of this type is suitable for example for security modules which have not implemented security mechanisms acting directly on data to be transferred, but rather make available corresponding further security mechanisms. This can comprise for example a functionality of key management, of the authentication of a user or of specific data, the generation of random numbers or the like. Furthermore, a design of this type is suitable e.g. also for security modules which have a dedicated interface for communication with one or more external apparatuses.

Here, too, provision can be made for the control basic device to comprise a plurality of data buses, wherein only one data bus is not passed through the security module, a plurality of the data buses are not passed through the security module or none of the data buses is passed through the security module.

In this regard, it is possible, for example, that in the case of two data buses provided in the control basic device, one of the data buses is passed through the security module, while another data bus is not passed through the security module. In this way, by way of example, a communication from a secure environment can be security-technologically protected, for example encrypted or monitored, while a communication within a secure zone, for example via a field bus in an automation system, can be effected in an unsecured manner.

In a further advantageous design, the security module can comprise a dedicated external module interface for communication with one or more external apparatuses. Via said interface, the security module can be connected or have been connected for example directly to one or more other control apparatuses, one or more computers (e.g. to an engineering system or a SCADA system), one or more field devices, one or more other security modules (e.g. in accordance with the present description).

In this case, the interface can be formed and configured for example as a field bus interface, an Ethernet interface, an Internet interface or as a comparable communication interface. It would thus be possible, for example, to adapt a security control apparatus in accordance with the present description e.g. to existing, different and/or customer-specific security protocols on a field bus interface of an automation system.

The control basic device can moreover comprise an identification apparatus, which can be formed and configured in such a way that, by means of the identification apparatus, it is possible to ascertain whether or not a security module is connected to the control basic device via the data interface.

Such an identification apparatus can be formed and configured for example as a separate software application or else hardware assembly, or else for example as part of the operating system or of “firmware” of the control basic device. The identification device can also furthermore be formed and configured such that it is configured and formed for the interrogation of identification information of the security module and its storage and if appropriate also checking. Furthermore, it can also be formed and configured for authenticating or checking the authenticity of a connected security module.

In this regard, provision can furthermore be made for the control basic device to be formed and configured in such a way that at least one functionality of the control basic device is prevented if no security module connected via the data interface is identified by the identification apparatus. What can be achieved in this way, for example, is that specific functionalities of the control basic device are available only if a corresponding security module is connected to the basic device.

Furthermore, provision can also be made for essential parts or the entire control functionality of the control basic device to be prevented or stopped if no security module connected via the data interface is identified by the identification apparatus.

The control basic device can furthermore be formed and configured in such a way that if no security module connected via the data interface is identified by the identification apparatus, a dedicated basic device crypto functionality provided in the control basic device is used instead of a cryptographic functionality of a security module.

In this way, by way of example, a secure basic functionality of the control basic device or a minimum security of said device can be achieved by virtue of the fact that, if no security module is connected to the control basic device, a dedicated crypto functionality implemented in the latter is used. In this case, the dedicated basic device crypto functionality can be formed and configured in a manner corresponding to a cryptographic functionality of a security module in accordance with the present description.

In this case, a control basic device formed as explained above can furthermore be designed and configured such that a cryptographic functionality of a connected security module is used instead of the dedicated basic device crypto functionality or else in combination with the dedicated basic device crypto functionality if a security module connected via the data interface is identified by the identification apparatus.

What can be achieved in this way is that for example during use of a security module with the control basic device, the functionality of the security module is then actually also used. In this regard, a corresponding security control apparatus can be configured in a flexible manner by virtue of the fact that, for example, a dedicated basic device crypto functionality provided in the basic device is provided as basic functionality and for example extended, improved or additional security functionalities can be added via corresponding security modules.

In a further advantageous design, provision can be made for the modular security control apparatus to comprise a further security module, which is formed and configured for providing or implementing a further cryptographic functionality for the control basic device, wherein the further security module is connected to the control basic device by means of a further data connection via a further data interface.

Furthermore, provision can also be made of additional security modules in a manner corresponding to the further security module.

The further security module comprises e.g. a further cryptographic functionality, which can be formed and configured in a manner corresponding to the cryptographic functionality of the security module in accordance with the present description. The further cryptographic functionality can for example supplement the cryptographic functionality of the security module or make an additional functionality available to the control basic device. Furthermore, the further cryptographic functionality can also correspond to the cryptographic functionality of the security module.

As mutually complementary cryptographic functionalities of the security module and of the further security module, provision can be made, for example, for the cryptographic functionality of the security module to comprise management of keys, while the further cryptographic functionality of the further security module comprises encryption of data. In this way, the mechanisms of key management and the actual encryption, which mechanisms are to be handled entirely differently, can be implemented in two different, mutually complementary security modules.

In this case, the further security module can in turn be formed and configured in a manner corresponding to a security module in accordance with the present description. In particular, the further security module can for example be releasably connected to the control basic device, wherein this releasable connection can likewise once again be formed in accordance with the present description. Furthermore, the further security module can also for example be fixedly connected to the control basic device or fixedly integrated into the latter. The further security module can for example also be provided as electronics or “hardware” programmable or configurable by a user or customer, e.g. be formed and configured as a so-called “Field Programmable Gate Array” (FPGA).

Via such an FPGA, a user can for example permanently implement the user's own security mechanisms in a corresponding security control apparatus. In this way, the security properties of a system of this type can be further improved since a user can use the latter's own security mechanisms known only to said user and an increased security of such a system can thus be achieved.

The further data interface can furthermore be formed and configured in a manner corresponding to a data interface in accordance with the present description. In particular, it can once again be provided as a wired and/or wireless interface. In this case, the further data interface can correspond to the data interface to the security module or else be formed as a different interface type or a different interface modification.

A security control apparatus comprising a security module and a further security module can furthermore be formed in such a way that the control basic device is formed and configured for cooperating with the further security module in order to achieve a further security function of the security control apparatus. In this case, the further security function can be formed and configured in a manner corresponding to a security function in accordance with the present description. In particular, the cooperation of the control basic device with the further security module can also be formed and configured in a manner corresponding to the cooperation of the control basic device with the security module in accordance with the present description.

Moreover, a security control apparatus comprising security module and further security module can also be designed and configured in such a way that the further security module is formed and configured for directly cooperating with the security module.

Such cooperation of both security modules can be effected for example via the respective data interface to the control basic device and/or else via a further data interface for direct communication of both security modules.

In this way, the modules can directly cooperate and jointly realize for example mutually complementary or additive security functions. In this regard, the protection of the data exchange in the context of the cooperation e.g. of authentication, integrity and/or encryption functionalities can be achieved for example by means of such cooperation of two modules.

A modular security control apparatus in accordance with the present description can furthermore be formed and configured in such a way that the security module is formed and configured as an electronic component that is programmable or configurable by a user, in particular an electronic component that is fixedly programmable or configurable by a user.

In this case, an electronic component of this type can be formed and configured for example as a “hardware” element, for example an integrated circuit, or else as an electronic assembly. By way of example, the electronic component can be formed and configured as a so-called “Field Programmable Gate Array” (FPGA). This electronic component can for example be fixedly connected to the control basic module. Furthermore, the electronic component can also be releasably connected to the control basic module.

In this way, the security of the security control apparatus can be further improved by virtue of the fact that a user can implement the latter's own, proprietary security mechanisms in the control apparatus and a particular confidentiality protection of the security measures used thus becomes possible.

The above object is also achieved by a method for operating a modular security control apparatus in accordance with the present description, wherein the control basic device and the security module each have an interface connection element, via which the data connection between control basic device and security module is established. In this case, the method comprises the following steps:
disconnecting the data connection between the control basic device and the security module,
establishing a data connection via the data interface between the control basic device and a second security module with a second cryptographic functionality.

In this case, disconnecting the data connection between the control basic device and the security module can be effected for example by spatially separating the interface connection elements of control basic device and security module. Establishing the data connection between the control basic device and the second security module can be effected for example by means of bringing close and/or contacting an interface connection element of the second security module and the interface connection element of the control basic device. In this case, establishing the data connection can furthermore also comprise a subsequent communication for establishing a functioning data connection.

Interface connection elements of the control basic device and the respective security module can comprise or consist of, for example, correspondingly cooperating connector elements, contact elements or else antennas. Furthermore, the second security module can be formed and configured in a manner corresponding to a security module in accordance with the present description.

The control basic device and the second security module can furthermore be formed and configured in such a way that the second security module is positionable on or in the control basic device and connectable thereto instead of the security module.

Furthermore, it can be provided that after establishing the data connection between the control basic device and the second security module via the data interface, identification information of the second security module is transferred to the control basic device and stored in the control basic device. Furthermore, it can also be provided that after establishing the data connection between the control basic device and the second security module via the data interface, identification information of the control basic device is transferred to the second security module and stored in the second security module. In this case, the respective transfer can be effected for example at the request of the respectively receiving device. Correspondingly, the transfer can also take place upon the instigation of the transmitting device. The identification information of the second security module can be designed and configured in a manner corresponding to identification information in accordance with the present description.

Furthermore, it can be provided that after establishing the data connection between control basic device and second security module, the control basic device checks an identity and/or an authenticity of the second security module. Furthermore, after establishing the data connection between control basic device and second security module, the second security module can also check an identity and/or authenticity of the control basic device.

In a further design, after an unsuccessful or erroneous check of the identity and/or authenticity of the second security module and/or of the control basic device, a security error measure can be initiated.

In this case, the identity and/or authenticity of the respective devices and/or modules can be implemented for example by checking identification data of said modules in accordance with the present description and/or else the authenticity of said data. If such an identity and/or authentication cannot be identified or verified, then an unsuccessful or erroneous check may be present and a corresponding security error measure can be initiated. Such a measure can comprise for example an alarm, a corresponding error message and/or stopping or preventing one, a plurality or all of the functionalities of the control basic device. The security error measure can be formed and configured for example in accordance with a security-relevant activity according to the present description.

By means of one or more security modules in accordance with the present description, it is possible for example for the first time to provide crypto functions for a modular security control apparatus in accordance with the present description. Furthermore, in this way for example it is also possible to replace crypto functions present in the security control apparatus or to supplement the crypto functions present there, wherein such a supplementation can preferably be effected in such a way that a security level of the combined crypto functions corresponds at least to a security level of each individual crypto function.

The object mentioned above is furthermore also achieved by a modular security control apparatus for controlling a device or an installation, comprising:
a control basic device, wherein the control basic device is formed and configured in such a way that a device that is connectable or connected to the control basic device or an installation that is connectable or connected thereto is controllable or is controlled by means of the execution of a control program in the control basic device, and
a security module that is formed and configured for providing or implementing a cryptographic functionality for the control basic device,
wherein the security module is connected to the control basic device by means of a data connection via a data interface, and
wherein the control basic device is formed and configured for cooperating with the security module in order to achieve a security function of the security control apparatus.

In this case, the security control apparatus, the control basic device, the security module, the data interface, the data connection, the cryptographic functionality and/or the security function can furthermore advantageously be formed and configured in accordance with the present description.

A modular security control apparatus of this type affords an improved possibility for example for data or communication security of a control apparatus of this type, since via the additional security module there is for example the possibility of adding own or externally developed security crypto-modules or similar modules for improving the security properties of the control apparatus. As a result of the cooperation of the functionality of the security module with the functionality already implemented in the basic device, it is thus possible, flexibly and if appropriate in a user-specific manner, for the security of a control apparatus to be improved and specifically and flexibly adapted.

Furthermore, in this way e.g. also by means of an independent implementation and/or own introduction of the security functionality in the context of the modular component a user can increase the trustworthiness of the security functionality since said user can thus utilize the high trustworthiness of the own controllable environment and is less or not dependent on the trustworthiness of third parties.

FIG. 1 shows a control arrangement 100 comprising an internal controller 110 for controlling an installation 500. The control arrangement 100 in this case represents one example of a control basic device in accordance with the present description. Via an internal data bus 140 and an I/O interface 150, a field bus connection 550 and a field bus 510, a control program running in the controller 110 controls the installation 500. Furthermore, the control arrangement 100 comprises a security data bus 130, via which a security module 200 in accordance with the present description is connected to the controller 110. The connection is effected via a connector element 120 of the control arrangement 100 and a corresponding mating connector element 220 of the security module 200.

The security module 200 comprises for example a key for encrypting data that are transmitted from the controller 110 to the installation 500.

In this case, the security module 200 can contain for example keys that are transmitted via the security data bus 130 to the controller 110 in order to be used there for encrypting the data transmitted to the installation 500. Alternatively, the security module 200 can also comprise the keys and the entire encryption logic, such that data to be sent for example from the controller 110 to the installation 500 firstly are transmitted via the security bus 130 to the security module, and are encrypted there, the encrypted data are transmitted back via the security data bus 130 to the controller 110 and from there to the installation 500.

FIG. 2 shows the control arrangement illustrated in FIG. 1, wherein the security module 200 in the design illustrated in FIG. 1 has an additional external communication interface with an external connection element 227, via which direct communication with an external data processing apparatus is possible. The external communication interface of the security module 200 can be formed e.g. as an Ethernet or Internet interface or else as a field bus interface with an external connection element 227 correspondingly adapted to the interface type. Via said external communication interface of the security module 200, e.g. the security module can communicate directly, or else alternatively the controller 110 can communicate via the security module 200, with a further control arrangement, a computer, the installation 500 or else a further security module in accordance with the present description (e.g. within a further security control apparatus in accordance with the present description).

FIG. 3 shows an alternative design of the control arrangement 100, wherein the control arrangement 100 comprises an additional connector 128 for contacting an additional mating connector 228 of the security module 200 and the data connection 140 to the I/O interface 150 of the control arrangement 100 is now effected directly by the additional connector 128 of the control arrangement 100. With this design, by way of example, the encryption of data transmitted to the installation 500 can be achieved more simply by virtue of the fact that for example the controller 110 transmits the data to be sent via the security data bus 130 to the security module 200, said data are encrypted there and are then sent in a directly encrypted manner from the security module via the I/O data bus 140 and the field bus 510 to the installation 500.

FIG. 4 shows a further design possibility for the control arrangement 100, in which, in addition to the security module, a further security module 300 is connected to the controller 110 via the security data bus 130. The further security module 300 comprises a further mating connector element 320, via which, via a further connector element 122 of the control arrangement 100, the communication of the further security module 300 can be effected via the security data bus 130.

In this case, the control arrangement 100, the security module 200 and the further security module 300 can be formed in such a way that the controller 110 communicates separately in each case with each of the security modules 200, 300 and in each case for example retrieves supplementary information at the security modules 200, 300 and/or sends said information there. Alternatively, the security modules 200, 300 can also be formed in such a way that they are capable of communication among one another via the security data bus 130.

In this way, the security modules 200, 300 can also interact directly. The system illustrated in FIG. 4 can be configured for example in such a way that the first security module 200 comprises a key management system, while the second security module 300 itself comprises an encryption mechanism. In the case of such a system, by way of example, the key management can be effected between the controller 110 and the first security module 200 and the subsequent encryption can be effected afterward in the second security module 300. Alternatively, by means of the first security module and the key management implemented there, a corresponding key can be made available via the security data bus 130 to the second security module 300 and data present there or data transferred from the controller 110 to the second security module 300 can be encrypted. Said data can then subsequently be transferred for example to the installation 500 via the controller 110 and the field bus 510.

In a modification of the design illustrated in FIG. 4, alternatively a further security data bus can be provided (not illustrated in FIG. 4), which exclusively connects the two security modules 200, 300. Said security data bus may either be present as part of the control arrangement 100 or else connect the two modules directly, e.g. outside the basic device, via a separate component (e.g. a cable).

FIG. 5 shows by way of example an encryption sequence using the control arrangement 100 illustrated in FIG. 1, wherein the controller 110 has a dedicated internal crypto functionality in accordance with the present description. In FIG. 5, in a first method step 600, data are input and, in a second method step 610, said data are processed using the internal crypto functionality of the controller 110 and the crypto functionality of the security module 200. In a third method step 620, these processed data are then output.

FIG. 6 shows a further exemplary embodiment of the invention as a flow diagram of the method according to embodiments of the invention for transmitting cryptographically protected network packets.

The method comprises a first method step 610 for selecting network packets by means of a packet filter using predefined selection parameters.

The method comprises a second method step 620 for cryptographically processing at least one network packet portion of the respectively selected network packets.

The method comprises a third method step 630 for adapting the cryptographically processed network packets to a first destination network.

The method comprises a fourth method step 640 for transmitting the cryptographically processed network packets as cryptographically protected network packets to the first destination network.

FIG. 7 shows a further exemplary embodiment of the invention as a flow diagram of the method according to embodiments of the invention for receiving cryptographically protected network packets.

The method comprises a first method step 710 for receiving and selecting network packets by means of a packet filter using predefined selection parameters, wherein at least one network packet portion of the selected network packets is cryptographically protected.

The method comprises a second method step 720 for canceling and/or evaluating a cryptographic protection of the protected network packet portion of the respectively selected network packets.

The method comprises a third method step 730 for adapting the evaluated and/or the network packets without cryptographic protection to a second destination network.

The method comprises a fourth method step 740 for transmitting the evaluated network packets and/or the network packets without cryptographic protection to the second destination network.

FIG. 8 shows a further exemplary embodiment of the invention as a first modular security control apparatus 800 for transmitting cryptographically protected network packets.

The first modular security control apparatus 800 comprises a control basic device 100, a first classification unit 820, a first security module 210, a first packet adapting unit 840, a first communication interface 804 (e.g. for linking to a first source network) and a second communication interface 805 (e.g. for linking to a first destination network), which are communicatively connected to one another via a first bus 803.

The bus can be realized for example such that in each case a point-to-point communication is realized for the units/components in order that in particular only the data necessary for processing are exchanged between the corresponding units/components.

The first modular security control apparatus 800 can for example additionally also comprise one further or a plurality of further component(s) such as, for example, a processor, a memory component, an input device, in particular a computer keyboard or a computer mouse, and a display device (e.g. a monitor). The further component(s) can be communicatively connected to one another for example likewise via the first bus 803.

The first classification unit 820 is configured by means of a packet filter for selecting network packets using predefined selection parameters.

The first classification unit 820 can be realized for example by means of a processor (e.g. processor of the first modular security control apparatus 800 or of the first security module 210), a memory component (e.g. a memory component of the first modular security control apparatus 800 or of the security module 210) and a first program component (e.g. packet filter), wherein for example the processor is configured by execution of program commands of the first program component or the processor is configured by the program commands in such a way that the network packets are selected.

The first security module 210 is configured for cryptographic processing of at least one network packet portion of the selected network packets, wherein the first security module 210 is connected to the first control basic device 100 by means of a data connection via a data interface (which e.g. is connected to the first bus 803 or is a part of the first bus 803) and the control basic device 100 is configured optionally/in particular for interrogating an identity and/or authenticity of the first security module 210. In this case, the abovementioned data interface is provided with the reference sign 150 in the subsequent FIGS. 11-14. The data interface can be realized for example as a plug connection.

The first security module 210 can be realized for example by means of a processor (e.g. a processor integrated in the first security module 210), a memory component (e.g. memory component integrated in the first security module 210) and a second program component (e.g. a program library with cryptographic functions such as OpenSSL), wherein for example the processor is configured by execution of program commands of the second program component or the processor is configured by the program commands in such a way that the first security module 210 carries out said functions. The processor and the memory component can form for example an integral first processor unit (reference sign 215 in FIGS. 10-14) of the first security module 210, as is illustrated in the subsequent FIGS. 10-14.

The first packet adapting unit 840 is configured to adapt the cryptographically processed network packets to the first destination network.

The first packet adapting unit 840 can be realized for example by means of a processor (e.g. processor of the first modular security control apparatus 800 or of the first security module 210), a memory component (e.g. memory component of the first modular security control apparatus 800 or of the first security module 210) and a third program component, wherein for example the processor is configured by execution of program commands of the third program component or the processor is configured by the program commands in such a way that the network packets are adapted.

Moreover, the control basic device 100 is configured for cooperating with the first security module 210 in order that the first modular security control apparatus 800 transmits the cryptographically processed network packets as cryptographically protected network packets to the first destination network.

The control basic device 100 can be realized for example by means of a processor (e.g. processor of the first modular security control apparatus 800), a memory component (e.g. memory component of the first modular security control apparatus 800) and a fourth program component, wherein for example the processor is configured by execution of program commands of the fourth program component or the processor is configured by the program commands in such a way that the control basic device 100 realizes the necessary functions.

FIG. 9 shows a further exemplary embodiment of the invention as a second modular security control apparatus 900 for receiving cryptographically protected network packets.

The second modular security control apparatus comprises a control basic device 100, a second classification unit 920, a second security module 220, a second packet adapting unit 940, a third communication interface 904 (e.g. for linking to a first destination network) and a fourth communication interface 905 (for linking to a second destination network), which are communicatively connected to one another via a second bus 903.

The bus can be realized for example such that in each case a point-to-point communication is realized for the units/components in order that in particular only the data necessary for processing are exchanged between the corresponding units/components.

The second modular security control apparatus 900 can for example additionally also comprise one further or a plurality of further component(s) such as, for example, a processor, a memory component, an input device, in particular a computer keyboard or a computer mouse, and a display device (e.g. a monitor). The further component(s) can be communicatively connected to one another for example likewise via the second bus 903.

The second classification unit 920 is configured by means of a packet filter for selecting network packets using predefined selection parameters, wherein at least one network packet portion of the selected network packets is cryptographically protected.

The second classification unit 920 can be realized for example by means of a processor (e.g. processor of the second modular security control apparatus 900 or of the second security module 220), a memory component (e.g. memory component of the second modular security control apparatus 900 or of the second security module 220) and a first program component (e.g. packet filter), wherein for example the processor is configured by execution of program commands of the first program component or the processor is configured by the program commands in such a way that the network packets are selected.

The second security module 220 is configured for canceling and/or evaluating a cryptographic protection of the protected network packet portion of the selected network packets, wherein the second security module 220 is connected to the control basic device 100 by means of a data connection (which e.g. is connected to the second bus 903 or is a part of the second bus 903) via a data interface and the control basic device 100 is configured optionally/in particular for interrogating an identity and/or authenticity of the security module. In this case, the abovementioned data interface is provided with the reference sign 150 in the subsequent FIGS. 11-14. The data interface can be realized for example as a plug connection.

The second security module 220 can be realized for example by means of a processor (e.g. a processor integrated in the second security module 220), a memory component (e.g. a memory component integrated in the second security module 220) and a second program component (e.g. a program library with cryptographic functions such as OpenSSL), wherein for example the processor is configured by execution of program commands of the second program component or the processor is configured by the program commands in such a way that the second security module 220 carries out said functions. The processor and the memory component can form for example an integral second processing unit (reference sign 225 in FIGS. 10-11 or in the analogous second modular security control apparatuses in FIGS. 12-14) of the second security module 220, as is illustrated in the subsequent FIGS. 10-14.

The second packet adapting unit 940 is configured to adapt the evaluated network packets and/or the network packets without cryptographic protection to the second destination network.

The second packet adapting unit 940 can be realized for example by means of a processor (e.g. a processor of the second modular security control apparatus 900 or of the second security module 220), a memory component (e.g. memory component of the second modular security control apparatus 900 or of the second security module 220) and a third program component, wherein for example the processor is configured by execution of program commands of the third program component or the processor is configured by the program commands in such a way that the network packets are adapted.

Moreover, the control basic device 100 is configured for cooperating with the first security module 220 in order that the second modular security control apparatus transmits the evaluated and/or the network packets without cryptographic protection (that is to say the network packets with the canceled cryptographic protection) to the second destination network.

The control basic device 100 can be realized for example by means of a processor (e.g. processor of the second modular security control apparatus 900), a memory component (e.g. memory component of the second modular security control apparatus 900) and a fourth program component, wherein for example the processor is configured by execution of program commands of the fourth program component or the processor is configured by the program commands in such a way that the control basic device 100 realizes the necessary functions.

In other words, embodiments of the invention (and the abovementioned exemplary embodiments, in particular the exemplary embodiments in FIGS. 6-9) makes it possible in particular to realize division and synchronization of the pure crypto functionality (encryption, cryptographic integrity protection) with the necessary protocol adaptations within a modularly constructed device for the cryptographic processing of network traffic.

In particular, this division achieves the restriction of the information exchange for the processing of the network packets. By way of example, it is conceivable for the information exchanged to be restricted to the absolute minimum necessary (e.g. the security modules 210/220 do not have to know the network addresses of the packet). In this case, what is achieved in particular by secure (data/communication) interfaces is that for example no components obtain access to data which are not required for accomplishing their respective task. In particular, it is thereby possible to reduce a required trust in the individual components (non-trustworthy, e.g. manipulated, components) by virtue of the fact that for example components having slight or no security mechanisms can also be used.

The communication between the units/components (illustrated for example by arrows in the subsequent figures) can be realized as point-to-point communication for example via the secure interfaces; in this case, the corresponding/respective interfaces of the corresponding units/components are configured in such a way that in particular exclusively the data necessary for processing can be exchanged exclusively between the relevant components/units.

FIG. 10 shows here how the individual components/aspects of the exemplary embodiments elucidated in FIGS. 6-9 cooperate.

Specifically, FIG. 10 shows on the left-hand side S the elements of the embodiment illustrated in FIG. 8 which realize the method steps 610, 620, 630, 640 shown in FIG. 6. The shown elements of the first modular security control apparatus 800 (FIG. 8) are the first classification unit 820 and the first packet adapting unit 840. In addition, the first processing unit 215 of the first security module is also shown.

The right-hand side R of FIG. 10 illustrates the elements of the embodiment illustrated in FIG. 9 which realize the method steps 710, 720, 730, 740 shown in FIG. 7. The shown elements of the second modular security control apparatus (FIG. 9) are the second classification unit 920 and the second packet adapting unit 940. In addition, the second processing unit 225 of the second security module is also shown.

The first modular security control apparatus and the second modular security control apparatus are communicatively connected to one another via a first destination network 1016 (e.g. a WAN or the Internet). In this case, the first destination network 1016 is for example a non-trustworthy network.

The first modular security control apparatus is moreover linked to a first source network 1010 (e.g. an Ethernet network). The second modular security control apparatus is moreover linked to a second destination network 1012 (e.g. an Ethernet network).

Moreover, the first modular security control apparatus can optionally comprise a first packet supplementary data processing unit 825. Analogously, the second modular security control apparatus can also comprise an optional second packet supplementary data processing unit 925.

In method step 610, network packets that reach the first modular security control apparatus from the first source network in the transmission direction are firstly selected by the classification unit 820. This selection is effected on the basis of freely configurable assessment parameters (e.g. by means of the predefined selection parameters), which are stored for example in a first configuration unit 821.

In one variant, the classification unit can determine the network packet portion, i.e. the segment of a network packet, which is subjected to cryptographic processing. This is advantageous since that portion of a network packet which is to be processed cryptographically can be determined in a flexible manner. By way of example, a layer2 encryption, a layer3 encryption or a cryptographic protection of an application protocol or only of an application protocol data field can be effected as a result. As a result, it is possible for only a relevant portion of a data packet (also referred to as a network packet) to be cryptographically protected in a targeted manner. A device consisting of control basic device and security module can be used in particular in a flexible manner in order to cryptographically process different packet portions of different packet types. This makes it possible, in particular in the industrial sphere, to take account of the different protection requirements and real-time requirements during the transfer of data packets/network packets. In this regard, application-specific processing can be carried out in the case of particularly real-time-critical control commands or in the case of a safety protocol, whereas monitoring data are protected according to an IPsec or TLS method.

Furthermore, by way of example, the classification unit can determine a key or a security relationship. As a result, it is possible to determine e.g. a security relationship for layer2 protection such as e.g. MACsec of a network packet depending on an application protocol contained in the data packet (e.g. network packet), or an application protocol parameter.

The following is advantageous inasmuch as a security module can be used to carry out different types of cryptographic processing of a packet. In summary, in particular the classification unit determines what portion of a data packet/network packet is intended to be preferably cryptographically processed in what way. By contrast, the security module preferably carries out the cryptographic processing of the selected packet portion in accordance with the cryptographic processing type determined. The cryptographic processing type determined can be provided to the security module for example as a control parameter. This architecture enables e.g. a flexible realization of different cryptographic methods and on different protocol layers. By contrast, the security module is responsible in particular only for carrying out the cryptographic processing, without having to realize in particular a network protocol processing function.

In one variant, the classification unit determines a sequence of processing steps that are carried out by the security module. This is advantageous since a plurality of cryptographic processing steps are predefinable by the same security module. By way of example, a first processing step can concern the cryptographic processing of a parameter of an application protocol, and a second processing step can concern an IP data packet.

In a further variant, a processing type checking unit is provided, which checks the processing step determined for permissibility using a positive list of permissible processing types. In particular, a processing by the security module is enabled only in the event of positive checking.

In a further variant, a license code or a configuration parameter can be used to approve what processing types are permissible. The checking can be carried out in particular by the control basic device, by the security module or by an additional processing type checking component.

A security module can provide in particular information regarding what processing types can be carried out by the security module. This information can preferably be used to check that a processing type determined by the classification unit can be carried out.

In a further variant, a plurality of security modules are provided. One of the plurality of security modules can be selected depending on the processing type determined.

The assessment/selection can be based on arbitrary portions of the processed network packet such as e.g. message type (IP packet, UDP packet, Broadcast packet) or packet header. By way of example, a program library, such as e.g. PCAP, can be used for this purpose. Alternatively, this functionality can also be realized in hardware by virtue of this being realized for example by means of a hardware implementation based on TCAMs (ternary content-addressable memory).

Those portions of the network packet which are processed by the first processing unit 215 of the first security module or are subjected to a cryptographic processing by the first processing unit 215 (method step 620) are obtained as a result.

In addition, packet supplementary data are stored for each packet in method step 611. By way of example, if the first modular security control apparatus comprises the first packet supplementary data processing unit 825, then said packet supplementary data can be stored by the first packet supplementary data processing unit 825.

The packet supplementary data make available in particular information required for the packet adaptation of the cryptographically processed network packets by the packet adapting unit 840 before these are transferred to the first destination network. In addition, the packet supplementary data can describe those data of a network packet which have not been cryptographically processed and which then need not be adapted, for example.

This is relevant, for example, if transmission addresses and/or destination address for the first source network and/or the second destination network have been encrypted. By way of example, for transmission via the first destination network the network packet or the data content thereof would be inserted into a new network packet comprising the corresponding addresses of the first modular security control apparatus and/or of the second modular security control apparatus as transmission addresses and/or destination address.

The packet supplementary data can also serve for controlling the cryptographic processing (e.g. key selection) and influence the cryptographic processing e.g. in a method step 612. The packet supplementary data can be constituted/constructed in particular from portions of the originally selected network packet. In particular, a portion of the cryptographically processed network packet can contain the packet supplementary data explicitly in cryptographically processed form or cryptographically unprocessed form.

By means of the packet adapting unit 840, in particular the cryptographically processed portions of the respectively selected network packet are adapted to the properties of the first destination network.

Alternatively or additionally, the non-cryptographically processed portions of the respectively selected network packet are adapted to the properties of the first destination network.

These are e.g. allowed protocols (e.g. TCP/IP or UDP) or the subnetwork mask of the respective network packet is adapted to the subnetwork mask of the first destination network.

In one variant, the packet supplementary data or a subset of the packet supplementary data are/is likewise transferred to the packet adapting unit 840 in a method step 613 after validation/processing/filtering by the first processing unit 215 and/or the first packet supplementary data processing unit 825.

After the adaptation of the network packets in method step 630, the cryptographically protected network packets are transferred to the first destination network by the first modular security control apparatus in method step 640.

This division is advantageous since in particular the cryptographic core functionality (the processing unit 215) of the security module for the cryptographic protection of the selected network packets need not be specifically designed for specific network protocols. On the basis of the packet supplementary data, in particular a selected network packet is assigned the information regarding how the corresponding network packet is intended to be cryptographically processed by the processing unit 215.

As a result, it is possible, for example, to support different network protocols by adapting the predefined selection parameters (“classification rules”).

As explained above there are various possibilities for providing the packet supplementary data to the first adapting unit and/or to the first security module or to its first processing unit 215. The packet supplementary data can either be communicated jointly with the selected and/or cryptographically processed network packets (in-band transfer). Alternatively, the packet supplementary data can be communicated via a separate data bus (out-of-band transfer), as is indicated in FIG. 10.

In a further variant, during the processing of the packet supplementary data by the first packet supplementary data processing unit 825 it is ensured that only specific information reaches the packet adapting unit 840. In particular, the entire packet to be transmitted can be encrypted because the packet adapting unit 840 only has to evaluate the packet supplementary information in order to adapt the packets for sending.

In a further variant, the cryptographic processing is parameterized (e.g. key selection) on the basis of the information of the packet supplementary data. This is advantageous particularly if different keys are intended to be used for different connections. The encryption component can then select the respective keys to be used using simple rules, e.g. a one-to-one assignment of packet supplementary data to key identifiers.

In a further variant, the first packet supplementary data processing unit 825 is an integral part of the classification unit 820.

The second modular security control apparatus is formed in an analogous manner to the first modular security control apparatus. In this regard, the second modular security control apparatus comprises a second configuration unit 921 for storing predefined selection parameters and a second packet supplementary data processing unit 925.

Moreover, the packet supplementary data are processed in an analogous manner. The second classification unit 920 selects the network packets in a method step 710 and stores the packet supplementary data in a method step 711. If the second modular security control apparatus comprises the second packet supplementary data processing unit 925, then the packet supplementary data are stored and/or processed in the second packet supplementary data processing unit 925. Said packet supplementary data are provided to the second processing unit 225 of the second security module 220 in a method step 712 in order that the packet supplementary data can be taken into account in method step 720. Alternatively or additionally, packet supplementary data or a subset of the packet supplementary data can be provided to the packet adapting unit 940 in a method step 713.

After the adaptation of the network packets in method step 740, the network packets (with evaluated and/or canceled cryptographic protection) are transferred to the second destination network 1012 by the second modular security control apparatus.

The architecture described can equally be used for L2 and L3 encryption.

Depending on the requirement, the various components can be distributed between basic device and separate, e.g. changeable, security module. Corresponding variants are explained in the following exemplary embodiments.

The figures show exemplary embodiments in which the individual units (e.g. classification units, processing units, adapting units) are formed in each case as integral components either of the control basic device or of the corresponding security module.

FIG. 11 shows a further exemplary embodiment using the exemplary embodiments from FIGS. 1-10, in particular the exemplary embodiments from FIGS. 6-10. Correspondingly, other advantageous design possibilities from these figures can also be applied to this exemplary embodiment.

The first modular security control apparatus 800 (e.g. a first modular security control apparatus 800 as shown in FIG. 8) comprises a first communication interface 804 (for linking to the first source network 1010), a second communication interface 805 (for linking to the first destination network 1016), a first processing unit 215, a control basic device 100 and a first security module 210, wherein the security module is communicatively connected to the control basic device 100 via a data interface 150.

The second modular security control apparatus 900 (e.g. a first modular security control apparatus 900 as shown in FIG. 9) comprises a third communication interface 904 (for linking to the first destination network 1016), a fourth communication interface 905 (for linking to the second destination network 1012), a control basic device 100, a second processing unit 225 and a first security module 220, wherein the security module is communicatively connected to the control basic device 100 via a data interface 150.

The configuration units 821, 921, the classification units 820, 920 are formed as integral elements of the respective control basic device 100; whereas the adapting units 840, 940, the processing units 215, 225 and the packet supplementary data processing units 825, 925 are formed as integral elements of the respective security modules 210, 220.

The first communication interface 804 and/or the second communication interface 805 can be formed for example as integral elements of the control basic device 100. Alternatively, the first communication interface 804 and/or the second communication interface 805 can be formed as integral elements of the security module 210.

The third communication interface 904 and/or the fourth communication interface 905 for the second modular security control apparatus 900 can be formed in an analogous manner.

Via the first communication interface 804, in this case the first classification unit 820 has access to the first source network 1010 for selecting the network packets.

Via the second communication interface 805, the cryptographically protected network packets are transferred or transmitted to the first destination network 1016.

Via the third interface 904, in this case the second classification unit 920 has access to the first destination network 1016 for selecting the cryptographically protected network packets.

Via the fourth interface 905, the evaluated and/or the network packets without cryptographic protection are transmitted/transferred to the second destination network 1012.

FIG. 12 shows a further exemplary embodiment using the exemplary embodiments from FIGS. 1-10, in particular the exemplary embodiments from FIGS. 6-10. Correspondingly, other advantageous design possibilities from these figures can also be applied to this exemplary embodiment. For the sake of simplicity, only the first modular security control apparatus 800 is illustrated in this exemplary embodiment. The reception end or the second modular security control apparatus can be designed in an analogous manner.

The first modular security control apparatus 800 (e.g. a first modular security control apparatus 800 as shown in FIG. 8) comprises a first communication interface 804 (for linking to the first source network 1010), a second communication interface 805 (for linking to the first destination network 1016), a first processing unit 215, a control basic device 100 and a first security module 210, wherein the security module is communicatively connected to the control basic device 100 via a data interface 150.

The first configuration unit 821, the first classification unit 820, the first adapting unit 840, the first processing unit 215 and the first packet supplementary data processing units 825 are formed as integral elements of the first security module 210.

The first communication interface 804 and/or the second communication interface 805 can be formed for example as integral elements of the control basic device 100. Alternatively, the first communication interface 804 and/or the second communication interface 805 can be formed as integral elements of the security module 210.

The third communication interface and/or the fourth communication interface for the second modular security control apparatus can be formed in an analogous manner.

Via the first communication interface 804, in this case the first classification unit 820 has access to the first source network 1010 for selecting the network packets.

Via the second communication interface 805, the cryptographically protected network packets are transferred or transmitted to the first destination network 1016.

FIG. 13 shows a further exemplary embodiment using the exemplary embodiments from FIGS. 1-10, in particular the exemplary embodiments from FIGS. 6-10. Correspondingly, other advantageous design possibilities from these figures can also be applied to this exemplary embodiment. For the sake of simplicity, only the first modular security control apparatus 800 is illustrated in this exemplary embodiment. The reception end or the second modular security control apparatus can be designed in an analogous manner.

The first modular security control apparatus 800 (e.g. a first modular security control apparatus 800 as shown in FIG. 8) comprises a first communication interface 804 (for linking to the first source network 1010), a second communication interface 805 (for linking to the first destination network 1016), a first processing unit 215, a control basic device 100 and a first security module 210, wherein the security module is communicatively connected to the control basic device 100 via a data interface 150.

The first configuration unit 821, the first classification unit 820, the first adapting unit 840 are formed as integral elements of the basic device 100.

The first processing unit 215 and the first packet supplementary data processing units 825 are formed as integral elements of the first security module 210.

The first communication interface 804 and/or the second communication interface 805 can be formed for example as integral elements of the control basic device 100. Alternatively, the first communication interface 804 and/or the second communication interface 805 can be formed as integral elements of the security module 210.

The third communication interface and/or the fourth communication interface for the second modular security control apparatus can be formed in an analogous manner.

Via the first communication interface 804, in this case the first classification unit 820 has access to the first source network 1010 for selecting the network packets.

Via the second communication interface 805, the cryptographically protected network packets are transferred or transmitted to the first destination network 1016.

FIG. 14 shows a further exemplary embodiment using the exemplary embodiments from FIGS. 1-10, in particular the exemplary embodiments from FIGS. 6-10. Correspondingly, other advantageous design possibilities from these figures can also be applied to this exemplary embodiment. For the sake of simplicity, only the first modular security control apparatus 800 is illustrated in this exemplary embodiment. The reception end or the second modular security control apparatus can be designed in an analogous manner.

The first modular security control apparatus 800 (e.g. a first modular security control apparatus 800 as shown in FIG. 8) comprises a first communication interface 804 (for linking to the first source network 1010), a second communication interface 805 (for linking to the first destination network 1016), a first processing unit 215, a first basic device processing unit 115, a control basic device 100 and a first security module 210, wherein the security module is communicatively connected to the control basic device 100 via a data interface 150.

The first processing unit 215 and the first packet supplementary data processing units 825 are formed as integral elements of the first security module 210.

The first communication interface 805 and/or the second communication interface 805 can be formed for example as integral elements of the control basic device 100. Alternatively, the first communication interface 805 and/or the second communication interface 805 can be formed as integral elements of the security module 210.

The third communication interface and/or the fourth communication interface for the second modular security control apparatus can be formed in an analogous manner.

Via the first communication interface 804, in this case the first classification unit 820 has access to the first source network 1010 for selecting the network packets.

Via the second communication interface 805, the cryptographically protected network packets are transferred or transmitted to the first destination network 1016.

Moreover, the cryptographic processing itself is distributed between security-module-internal processing and security-module-external processing. The security-module-internal processing is realized by the first processing unit 215, whereas the security-module-external processing is realized by the first basic device processing unit 115. Preferably/optionally there is a direct data path (dashed connection) from the classification unit 820 to the security-module-external processing 155, wherein the data path is realized in particular by means of a communication bus and an optionally secure interface.

The first processing unit 215 of the security module is intended to make available for example a key stream. The parameterization (e.g. choice of key and IV) of the key stream is carried out for example on the basis of the packet supplementary data. The first basic device processing unit 115 then combines for example the cleartext data with the key stream.

Alternatively or additionally, by way of example—depending on the implementation chosen—a data path (or a data connection) between the first packet supplementary data processing unit 825 and the first basic device processing unit 115 can be provided (not illustrated) in order to generate the cryptographically protected network packets for example in the first basic device processing unit 115. In the first adapting unit 840, in particular the packets are then also adapted to the first destination network 1016.

It may be expedient, for example, to subdivide the control basic device 100 by means of a first subdivision 130 into two control basic device subunits, for example a first subunit A and a second subunit B (e.g. a physical separation wherein each of the subunits, for realizing the functions thereof, has a dedicated processor and a dedicated memory component).

The first subunit A performs the classification/selection of the packets. Correspondingly, the first configuration unit 821 and the first classification unit 820 are formed as integral elements of the first subunit A of the control basic device 100.

The first adapting unit 840 and the first basic device processing unit 115 are formed as integral elements of the second subunit B of the control basic device 100.

In a further variant (not illustrated), the first packet supplementary data processing unit 825 is an integral element of the control basic device 100 (that is to say is shifted into the basic device). In this case, the first packet supplementary data processing unit 825 can be, if appropriate, a part of the first subunit A or of the second subunit B. As a result, the interface 150 is significantly simplified since the data intended for the component 840 do not have to be transferred via the external module.

The construction for the opposite communication direction can be realized in a mirror-inverted manner or analogously for a second modular security control apparatus. The control basic device of the second modular security control apparatus is also subdivided by means of a second subdivision into two control basic device subunits, for example a third subunit C and a fourth subunit D. Such a subdivision can be realized for this exemplary embodiment or other exemplary embodiments for example by means of a functional and/or an electrical and/or a spatial and/or a mechanical separation/subdivision/division of the corresponding components from one another. In this regard, in particular the corresponding components of the subunit C can be accommodated on a circuit board/printed circuit board and the components of the subunit D can be accommodated on a further circuit board/printed circuit board.

The third subunit C performs the classification/selection of the packets. Correspondingly, the second configuration unit and the second classification unit are formed as integral elements of the third subunit of the control basic device of the second modular security control apparatus.

The second adapting unit and a second basic device processing unit are correspondingly formed as integral elements of the fourth subunit C of the control basic device of the second modular security control apparatus.

This exemplary embodiment is advantageous inasmuch as the first cryptographic processing unit only obtains access to the packet supplementary data and has no access to the cleartext data (that is to say to the network packets that hereto have not yet been cryptographically processed). This is advantageous with regard to the trustworthiness and reduces the bandwidth of the interface between the basic device and the security module (e.g. cleartext data do not have to be transferred to the security module).

Moreover, it is possible, for example, that different embodiments of the modular security control apparatuses can be realized in each case for the transmitter and receiver ends and can be combined with one another (communicate with one another)—provided that they are designed in such a way that they realize in each case compatible cryptographic functionalities.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A first modular security control apparatus for transmitting cryptographically protected network packets, comprising:
a control basic device;
a first classification unit, wherein the first classification unit is configured by means of a packet filter for selecting network packets using predefined selection parameters;
a first security module, wherein the security module is configured for a cryptographic processing of at least one network packet portion of the selected network packets, the first security module being connected to the control basic device by means of a data connection via a data interface; and
a first packet adapting unit, wherein the first packet adapting unit is configured to adapt the cryptographically processed network packets to a first destination network, wherein the control basic device is configured for cooperating with the first security module in order that the first modular security control apparatus transmits the cryptographically processed network packets as cryptographically protected network packets to the first destination network.

2. The first modular security control apparatus as claimed in claim 1, wherein the first security module comprises the first packet adapting unit and/or the first classification unit.

3. The first modular security control apparatus as claimed in claim 1, wherein the control basic device comprises the first packet adapting unit and/or the first classification unit.

4. The first modular security control apparatus as claimed in claim 1, wherein the first security module is releasably connected to the control basic device.

5. The first modular security control apparatus as claimed in claim 4, wherein the control basic device, with the first security module having been released, is operable with a basic device functionality.

6. The first modular security control apparatus as claimed in claim 4, wherein the control basic device is furthermore configured for cooperating with a further security module—exchangeable for the first security module—with a second cryptographic functionality for the cryptographic processing and/or a further security function of the security control apparatus.

7. The first modular security control apparatus as claimed in claim 1, wherein
the control basic device comprises a housing,
in the housing a recess is formed and configured for at least partly receiving the first security module,
furthermore, an interface connection element for the data interface is provided in the control basic device in such a way that, with the first security module having been received in the recess, a data exchange between control basic device and first security module takes place.

8. The first modular security control apparatus as claimed in claim 1, wherein
the first classification unit is configured for storing packet supplementary data for a respective network packet and/or
the first packet adapting unit takes account of at least one portion of the packet supplementary data during adapting and/or
the first security module takes account of at least one portion of the packet supplementary data during cryptographic processing.

9. The first modular security control apparatus as claimed in claim 1, wherein
the units each have secure interfaces,
communication of data to the units or retrieval of data from the units is able to be carried out via the respective secure interface.

10. A second modular security control apparatus for receiving cryptographically protected network packets, comprising:
a control basic device;
a second classification unit, wherein the second classification unit is configured by means of a packet filter for selecting network packets using predefined selection parameters, wherein at least one network packet portion of the selected network packets is cryptographically protected;
a second security module, wherein the second security module is configured for canceling and/or evaluating a cryptographic protection of the protected network packet portion of the selected network packets, the second security module being connected to the control basic device by means of a data connection via a data interface; and
a second packet adapting unit, wherein the second packet adapting unit is configured to adapt the evaluated and/or the network packets without cryptographic protection to a second destination network, the control basic device is configured for cooperating with the second security module in order that the second modular security control apparatus transmits the evaluated and/or the network packets without cryptographic protection to the second destination network.

11. The second modular security control apparatus as claimed in claim 10, wherein
an integrity of the network packets is checked during evaluation,
the transmission of the network packets into the second network is suppressed depending on a result of the evaluation.

12. The second modular security control apparatus as claimed in claim 1, wherein
the second classification unit is configured for storing packet supplementary data for a respective network packet, and/or
the second packet adapting unit takes account of at least one portion of the packet supplementary data during adapting, and/or
the second security module takes account of at least one portion of the packet supplementary data during evaluation or cancellation of the cryptographic protection.

13. A method for transmitting cryptographically protected network packets comprising the following method steps:
selecting network packets by means of a packet filter using predefined selection parameters;
cryptographically processing at least one network packet portion of the respectively selected network packets;
adapting the cryptographically processed network packets to a first destination network; and
transmitting the cryptographically processed network packets as cryptographically protected network packets to the first destination network.

14. A method for receiving cryptographically protected network packets comprising the following method steps:
receiving and selecting network packets by means of a packet filter using predefined selection parameters, wherein at least one portion of a respective network packet is cryptographically protected;
canceling and/or evaluating a cryptographic protection of the protected network packet portion of the respectively selected network packets;
adapting the evaluated and/or the network packets without cryptographic protection to a second destination network; and
transmitting the evaluated network packets and/or the network packets without cryptographic protection to the second destination network.

15. A computer program product, comprising a computer readable hardware storage device having computer readable program code stored therein, said program code executable by a processor of a computer system to implement a method comprising program commands for carrying out the methods as claimed in claim 13.

16. A computer program product, comprising a computer readable hardware storage device having computer readable program code stored therein, said program code executable by a processor of a computer system to implement a method comprising program commands for a construction device which is configured by means of the program commands to construct one of the modular security control apparatuses as claimed in claim 1.

17. A providing device for the computer program product, comprising a computer readable hardware storage device having computer readable program code stored therein, said program code executable by a processor of a computer system to implement a method as claimed in claim 14, wherein the providing device stores and/or provides the computer program product.
